(19) United States
(12) Patent Application Publication
(10) Pub. No.: US 2012/0055668 A1
(43) Pub. Date: Mar. 8, 2012

(54) SOLVENTS AND COMPOSITIONS FOR TREATING HYDROCARBON-BEARING FORMATIONS

(76) Inventors: Yong K. Wu, Woodbury, MN (US); Rudolf J. Dams, Antwerp (BE); Steven J. Martin, Shoreview, MN (US); Wayne W. Fan, Cottage Grove, MN (US)

(21) Appl. No.: 13/320,089

(22) PCT Filed: May 11, 2009
(86) PCT No.: PCT/US2010/034192

§ 371 Date: Nov. 11, 2011

Related U.S. Application Data
(60) Provisional application No. 61/177,153, filed on May 11, 2009.

(51) Int. Cl. E21B 43/22; E21B 47/07; C09K 8/58

(52) U.S. Cl. 166/250.01; 507/205

(57) ABSTRACT

A method of treating a hydrocarbon-bearing formation that includes receiving data comprising a temperature and a brine composition of the hydrocarbon-bearing formation; selecting a treatment composition for the hydrocarbon-bearing formation comprising a fluorinated compound and solvent, wherein, at the temperature, a mixture of an amount of the brine composition and the treatment composition separates into at least two separate transparent liquid layers, and wherein the mixture is free of precipitated solid; and contacting the hydrocarbon-bearing formation with the treatment composition. Compositions containing certain fluorinated polymers and solvents containing water, monohydroxy alcohols, and ketones are also disclosed.

### CROSS REFERENCE TO RELATED APPLICATIONS

This application claims the benefit of U.S. Provisional Application No. 61/177,153, filed May 11, 2009, the disclosure of which is incorporated by reference herein in its entirety.

### BACKGROUND

In the oil and gas industry, certain surfactants (including certain fluorinated surfactants) are known as fluid additives for various downhole operations (e.g., fracturing, waterflooding, and drilling). Often, these surfactants function to decrease the surface tension of the fluid or to stabilize foamed fluids.

Some hydrocarbon and fluorochemical compounds have been used to modify the wettability of reservoir rock, which may be useful, for example, to prevent or remedy water blocking (e.g., in oil or gas wells) or liquid hydrocarbon accumulation (e.g., in gas wells) in the vicinity of the well bore (i.e., the near well bore region). Water blocking and liquid hydrocarbon accumulation may result from natural phenomena (e.g., water-bearing geological zones or condensate banking) and/or operations conducted on the well (e.g., using aqueous or hydrocarbon fluids). Water blocking and condensate banking in the near well bore region of a hydrocarbon-bearing geological formation can inhibit or stop production of hydrocarbons from the well and hence are typically not desirable. Not all hydrocarbon and fluorochemical compounds, however, provide the desired wettability modification. Also, delivery of such fluorochemical compounds to a hydrocarbon-bearing formation can be challenging (e.g., with certain brine compositions present in the hydrocarbon-bearing formations or at certain temperatures). It has generally been proposed that a formulation containing a fluorochemical compound and a solvent should not phase separate when it comes into contact with a hydrocarbon-bearing formation.

### SUMMARY

The methods of treating a hydrocarbon-bearing formation disclosed herein are typically useful for increasing the permeability in hydrocarbon-bearing formations with a wide range of brine compositions (e.g., connate brine and/or water blocking) Treatment of an oil and/or gas well that has brine in the near wellbore region using the methods disclosed herein may increase the productivity of the well. Although not wishing to be bound by theory, it is believed that the fluorinated compounds generally adsorb to or react with at least one of hydrocarbon-bearing formations or proppants under downhole conditions and modify the wetting properties of the rock in the formation to facilitate the removal of hydrocarbons and/or brine. The fluorinated compound may remain on the rock for the duration of an extraction of hydrocarbons from the formation (e.g., 1 week, 2 weeks, 1 month, or longer). The fluorinated compounds are generally delivered to hydrocarbon-bearing formations in treatment compositions comprising solvent, which treatment compositions may encounter brine in the hydrocarbon-bearing formation. It is believed that useful solvents will prevent the precipitation of the fluorinated compounds and dissolved salts when the treatment compositions encounter the brine. Such precipitation may inhibit the adsorption or reaction of the fluorinated compound on the formation, may clog the pores in the hydrocarbon-bearing formation thereby decreasing the permeability and the hydrocarbon and/or brine production, or a combination thereof.

Previous work suggested that the selection of treatment compositions that did not phase separate or cause precipitation upon encountering brine at a desired temperature were useful. It has now been found that treatment compositions that form at least two separate transparent liquid layers upon encountering brine at a desired temperature are effective for delivering a fluorinated compound to a hydrocarbon-bearing formation.

In one aspect, the present disclosure provides a method of treating a hydrocarbon-bearing formation, the method comprising:

receiving data comprising a temperature and a brine composition of the hydrocarbon-bearing formation;

selecting a treatment composition for the hydrocarbon-bearing formation comprising a fluorinated compound and solvent, wherein, at the temperature, a mixture of an amount of the brine composition and the treatment composition separates into at least two separate transparent liquid layers, and wherein the mixture is free of precipitated solid; and

contacting the hydrocarbon-bearing formation with the treatment composition,

wherein the hydrocarbon-bearing formation has at least one of a gas permeability or liquid permeability that is increased by more than 30 percent after the hydrocarbon-bearing formation is contacted with the treatment composition.

In another aspect, the present disclosure provides a method of treating a hydrocarbon-bearing formation, the method comprising:

receiving data comprising a temperature and a brine composition of the hydrocarbon-bearing formation;

selecting a treatment composition for the hydrocarbon-bearing formation comprising a fluorinated compound and solvent comprising at least one of a ketone, ester, ether, each having from 4 to 10 carbon atoms, or a hydrofluoroether or hydrofluorocarbon, wherein, at the temperature, a mixture of an amount of the brine composition and the treatment composition separates into at least two separate transparent liquid layers, and wherein the mixture is free of precipitated solid; and

contacting the hydrocarbon-bearing formation with the treatment composition.

In another aspect, the present disclosure provides a method of treating a hydrocarbon-bearing formation, the method comprising:

receiving data comprising a temperature and a first brine composition of the hydrocarbon-bearing formation;

contacting the hydrocarbon-bearing formation with a fluid, wherein after the fluid contacts the hydrocarbon-bearing formation, the hydrocarbon-bearing formation has a second brine composition that is different from the first brine composition;

selecting a treatment composition for the hydrocarbon-bearing formation comprising a fluorinated compound and solvent, wherein, at the temperature, a mixture of an amount of the second brine composition and the treatment composition separates into at least two separate transparent liquid layers, and wherein the mixture is free of precipitated solid; and

contacting the hydrocarbon-bearing formation with the treatment composition.

In some embodiments of the foregoing aspects, the fluorinated compound is a fluorinated polymer comprising:

at least one divalent unit selected from the group consisting of:

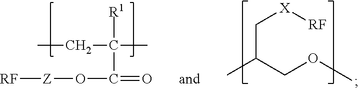

and a polyalkyleneoxy segment,
wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—;
each X is independently —N(R)SO₂—, —N(R)CO—, —O—CᵥH₂ᵥ—, —S—CᵥH₂ᵥ—, or —C_{w}H_{2w}—, wherein v and w are each values from 0 to 6; and
R¹ and R are each independently selected from the group consisting of hydrogen and alkyl having up to 4 carbon atoms.

In other embodiments of the foregoing aspects, the fluorinated compound comprises a fluorinated polyurethane having at least two repeat units, the fluorinated polyurethane comprising:
at least one end group represented by the formula -A¹-Z—RF, and
at least one end group represented by the formula -A¹-W—SiG₃;
   wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, wherein each R is independently hydrogen or alkyl having up to four carbon atoms;
each A¹ is independently selected from the group consisting of —NH—C(O)—N(R¹¹)—, —NH—C(O)—S—, —NH—C(O)—O—, —N(R¹¹)—C(O)—NH—, and —O—C(O)—NH—, wherein R¹¹ is hydrogen or alkyl having up to four carbon atoms;
each W is independently selected from the group consisting of alkylene, arylalkylene, and arylene, wherein alkylene is optionally interrupted with at least one —O—; and
each G is independently hydroxyl, alkoxy, acyloxy, aryloxy, halogen, alkyl, or phenyl, with the proviso that at least one G is hydroxyl, alkoxy, acyloxy, aryloxy, or halogen.

The present disclosure also provides a composition comprising:

a fluorinated polymer comprising:
at least one divalent unit represented by formula:

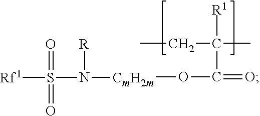

and
at least one unit selected from the group consisting of:

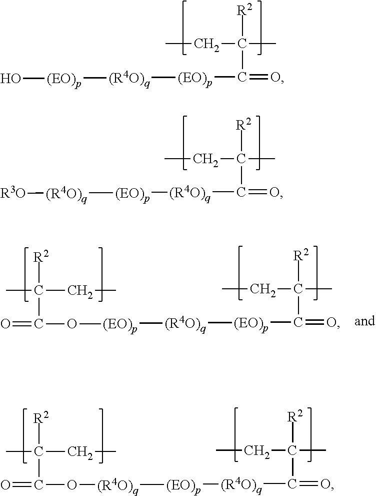

wherein
Rf¹ represents a perfluoroalkyl group having up to 8 carbon atoms;
R, R¹, R², and R³ are each independently selected from the group consisting of hydrogen and alkyl having up to 4 carbon atoms;
m is an integer from 1 to 11;
EO represents —CH₂CH₂O—;
each R⁴O is independently selected from the group consisting of —CH(CH₃)CH₂O—, —CH₂CH₂CH₂O—, —CH₂CH(CH₃)O—, —CH(CH₂CH₃)CH₂O—, —CH₂CH(CH₂CH₃)O—, and —CH₂C(CH₃)₂O—;
each p is independently 1 to 150; and
each q is independently 0 to 55; and solvent comprising:

water in a range from 5 to 40 percent by weight, based on the total weight of the composition;

a monohydroxy alcohol having up to 4 carbon atoms in a range from 25 to 60 percent by weight, based on the total weight of the composition; and

a ketone having from 4 to 10 carbon atoms in a range from 15 to 60 percent by weight, based on the total weight of the composition.

The present disclosure also provides a composition comprising a fluorinated polyurethane having at least two repeat units, the fluorinated polyurethane comprising:
at least one end group represented by the formula

—NH—C(O)—O—(CⱼH₂ⱼ)N(R″)S(O)₂—Rf²; and
at least one end group represented by the formula —NH—(CₖH₂ₖ)—SiG′₃;

wherein
each Rf² independently represents perfluoroalkyl having from 2 to 6 carbon atoms;
each R″ is independently hydrogen or alkyl having up to four carbon atoms;
each G′ is independently alkoxy or hydroxyl; and
j and k are each independently values from 1 to 6; and solvent comprising:

water in a range from 5 to 40 percent by weight, based on the total weight of the composition;

a monohydroxy alcohol having up to 4 carbon atoms in a range from 25 to 60 percent by weight, based on the total weight of the composition; and

a ketone having from 4 to 10 carbon atoms in a range from 15 to 60 percent by weight, based on the total weight of the composition.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The term “brine” refers to water having at least one dissolved electrolyte salt therein (e.g., having any nonzero concentration, and which may be less than 1000 parts per million by weight (ppm), or greater than 1000 ppm, greater than 10,000 ppm, greater than 20,000 ppm, 30,000 ppm, 40,000 ppm, 50,000 ppm, 100,000 ppm, 150,000 ppm, or even greater than 200,000 ppm).

The term “hydrocarbon-bearing formation” includes both hydrocarbon-bearing formations in the field (i.e., subterranean hydrocarbon-bearing formations) and portions of such hydrocarbon-bearing formations (e.g., core samples).

The term “treating” includes placing a composition within a hydrocarbon-bearing formation using any suitable manner known in the art (e.g., pumping, injecting, pouring, releasing, displacing, spotting, or circulating the fluorinated polymer into a well, well bore, or hydrocarbon-bearing formation.

The term “solvent” refers to a homogeneous liquid material (inclusive of any water with which it may be combined) that is capable of at least partially dissolving the fluorinated polymer disclosed herein at 25° C.

“Alkyl group” and the prefix “alk-” are inclusive of both straight chain and branched chain groups and of cyclic groups. Unless otherwise specified, alkyl groups herein have up to 20 carbon atoms. Cyclic groups can be monocyclic or polycyclic and, in some embodiments, have from 3 to 10 ring carbon atoms.

The term “polymer” refers to a molecule having a structure which essentially includes the multiple repetition of units derived, actually or conceptually, from molecules of low relative molecular mass. The term “polymer” encompasses oligomers.

The term “fluoroalkyl group” includes linear, branched, and/or cyclic alkyl groups in which all C—H bonds are replaced by C—F bonds as well as groups in which hydrogen or chlorine atoms are present instead of fluorine atoms provided that up to one atom of either hydrogen or chlorine is present for every two carbon atoms. In some embodiments of fluoroalkyl groups, when at least one hydrogen or chlorine is present, the fluoroalkyl group includes at least one trifluoromethyl group. Unless otherwise specified, fluoroalkyl groups herein have up to 30 (e.g., up to 25, 20, 15, 12, 10, 8, or 6) fluorinated carbon atoms.

The term “productivity” as applied to a well refers to the capacity of a well to produce hydrocarbons (i.e., the ratio of the hydrocarbon flow rate to the pressure drop, where the pressure drop is the difference between the average reservoir pressure and the flowing bottom hole well pressure (i.e., flow per unit of driving force)). The phrase “comprises at least one of followed by a list refers to comprising any one of the items in the list and any combination of two or more items in the list. Similarly, the phrase “at least one of followed by a list refers to any one of the items in the list and any combination of two or more items in the list.

The term “transparent” refers to allowing clear view of objects beyond. In some embodiments, transparent refers to liquids that are not hazy or cloudy. All numerical ranges are inclusive of their endpoints unless otherwise stated.

### BRIEF DESCRIPTION OF THE DRAWINGS

For a more complete understanding of the features and advantages of the present disclosure, reference is now made to the detailed description along with the accompanying figures and in which:

FIG. 1 is a schematic illustration of an exemplary embodiment of an offshore oil platform operating an apparatus for progressively treating a near wellbore region according to some embodiments of the present disclosure;

FIG. 2 is a schematic illustration of the core flood set-up used for Examples 12, 13, 14, and 15;

FIG. 3 is a schematic illustration of the core flood set-up used for Example 11 and Comparative Examples A and D; and

FIG. 4 is a schematic illustration of the flow apparatus used to evaluate Comparative Examples A and B for their effect on the relative permeability of sea sand or particulate calcium carbonate.

### DETAILED DESCRIPTION

Fluorinated compounds useful for practicing the present disclosure include fluorinated polymers (e.g., nonionic fluorinated acrylic copolymers or nonionic fluorinated polyalkyleneoxy copolymers), silane-functional fluorinated urethane oligomers, and fluorinated silanes. In some embodiments, fluorinated polymers useful for practicing the present disclosure comprise:

at least one divalent unit represented by the formula:

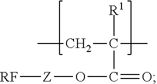

and a polyalkyleneoxy segment.

RF represents a fluoroalkyl group optionally containing at least one —O—. In some embodiments, RF represents a fluoroalkyl group having up to 12, 10, 8, or 6 fluorinated carbon atoms. In some embodiments, RF represents a polyfluoropolyether group having at least 10 fluorinated carbon atoms and at least three —O— groups. Z is selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, and wherein R and R¹ are independently selected from the group consisting of hydrogen and alkyl having up to 4 carbon atoms (e.g., methyl, ethyl, n-propyl, isopropyl, n-butyl, or isobutyl). In some embodiments, R is methyl or ethyl. In some embodiments, R¹ is hydrogen or methyl. The phrase “interrupted by at least one functional group” refers to having alkylene or arylalkylene on either side of the functional group. The term “terminated by a functional group” refers to the functional group being connected to the RF. In some embodiments Z is alkylene. In some embodiments, Z is —S(O)₂—N(R)-alkylene.

In some embodiments, fluorinated polymers useful for practicing the present disclosure comprise (e.g., at least 2, 3, 4, 5, 6, 7, 8, 9, 10, 15, or even at least 20 up 30, 35, 40, 45, 50, 100, or even up to 200) first divalent units independently represented by formula:

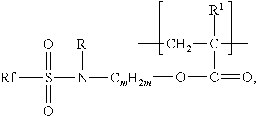

wherein R and R¹ are as defined above, and wherein m is an integer from 1 to 11 (i.e., 1, 2, 3, 4, 5, 6, 7, 8, 9, 10, or 11). In some embodiments, m is an integer from 2 to 11, 2 to 6 or 2 to 4.

In some embodiments, fluorinated polymers useful for practicing the present disclosure comprise (e.g., at least 2, 3, 4, 5, 6, 7, 8, 9, 10, 15, or even at least 20 up 30, 35, 40, 45, 50, 100, or even up to 200) first divalent units independently represented by formula:

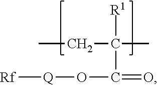

wherein Q is independently alkylene having up to 10 carbon atoms and optionally interrupted by at least one —O— (e.g., methylene, ethylene, propylene, butylene, pentylene, hexylene, heptylene, octylene, nonylene, decylene, or —(CH₂—CH₂—O)ₙ—CH₂—CH₂—, wherein n is an integer having a value from 1 to 4 (i.e., 1, 2, 3, or 4). In some embodiments, Q is —CH₂—CH₂—O—CH₂—CH₂— or —CH₂—CH₂—. In some embodiments, Q is methylene or ethylene.

For any of the embodiments of the first divalent units, each Rf independently represents a fluoroalkyl group having from 1 to 10 (in some embodiments, 1 to 8, 1 to 6, 2 to 6, or 2 to 4) carbon atoms (e.g., trifluoromethyl, perfluoroethyl, 1,1,2,2-tetrafluoroethyl, 2-chlorotetrafluoroethyl, perfluoro-n-propyl, perfluoroisopropyl, perfluoro-n-butyl, 1,1,2,3,3,3-hexafluoropropyl, perfluoroisobutyl, perfluoro-sec-butyl, or perfluoro-tert-butyl, perfluoro-n-pentyl, pefluoroisopentyl, perfluorohexyl, perfluoroheptyl, perfluorooctyl, perfluorononyl, or perfluorodecyl). In some embodiments of the compositions disclosed herein, Rf¹ represents a perfluoroalkyl group having up to 7, 6, 5, or 4 carbon atoms. In some embodiments, Rf or Rf¹ is perfluorobutyl (e.g., perfluoro-n-butyl, perfluoroisobutyl, or perfluoro-sec-butyl). In some embodiments, Rf or Rf¹ is perfluoropropyl (e.g., perfluoro-n-propyl or perfluoroisopropyl). Rf and Rf¹ may contain a mixture of fluoroalkyl groups (e.g., with an average of up to 8, 6, or 4 carbon atoms).

For any of the embodiments of the first divalent units, R¹ is hydrogen or alkyl have up to 4 carbon atoms (e.g., methyl, ethyl, n-propyl, isopropyl, n-butyl, or isobutyl). In some embodiments, R¹ is hydrogen. In some embodiments, R¹ is methyl.

The polyalkyleneoxy segment in fluorinated polymers useful for practicing the present disclosure can comprise a plurality (i.e., multiple) of repeating alkyleneoxy groups having from 2 to 4 or 2 to 3 carbon atoms (e.g., —CH₂CH₂O—, —CH(CH₃)CH₂O—, —CH₂CH(CH₃)O—, —CH₂CH₂CH₂O—, —CH(CH₂CH₃)CH₂O—, —CH₂CH(CH₂CH₃)O—, or —CH₂C(CH₃)₂O—). In some embodiments, the segment comprises a plurality of ethoxy groups, propoxy groups, or combinations thereof The polyalkyleneoxy segment may have a number average molecular weight of at least 200, 300, 500, 700, or even at least 1000 grams per mole up to 2000, 4000, 5000, 8000, 10000, 15,000, or even up to 20000 grams per mole. Two or more differing alkyleneoxy groups may be distributed randomly in the series or may be present in alternating blocks.

In some embodiments, the polyalkyleneoxy segment is present in units represented by formula:

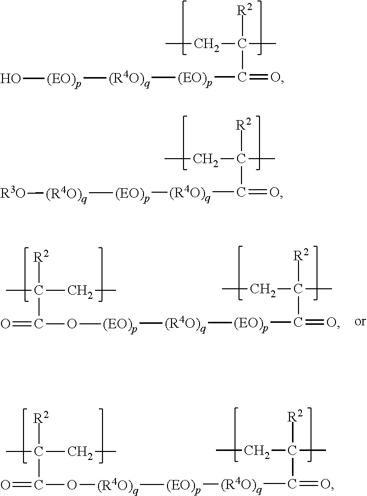

wherein R² and R³ are each independently hydrogen or alkyl having up to 4 carbon atoms (e.g., methyl, ethyl, n-propyl, isopropyl, n-butyl, or isobutyl). In some embodiments, R² and R³ are each independently hydrogen or methyl. In any of the aforementioned formulas, EO represents —CH₂CH₂O—, and each R⁴O independently represents —CH(CH₃)CH₂O—, —CH₂CH₂CH₂O—, —CH₂CH(CH₃)O—, —CH(CH₂CH₃)CH₂O—, —CH₂CH(CH₂CH₃)O—, or —CH₂C(CH₃)₂O—. In some embodiments, each R⁴O independently represents —CH(CH₃)CH₂O— or —CH₂CH(CH₃)O—. Each p is independently from 1 to about 150, and each q is independently from 0 to about 55. In some embodiments, q is in a range from 1 to 55. In some embodiments, the ratio p/q has a value from at least 0.5, 0.75, 1 or 1.5 to 2.5, 2.7, 3, 4, 5, or more. In some embodiments, at least a portion of the plurality of alkyleneoxy groups is present in sulfur-terminated segments.

In some embodiments, fluorinated polymers useful for practicing the present disclosure comprise:

first divalent units represented by formula:

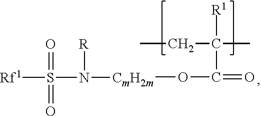

wherein Rf¹, R¹, R, and m are as defined above; and

second units comprising at least one of

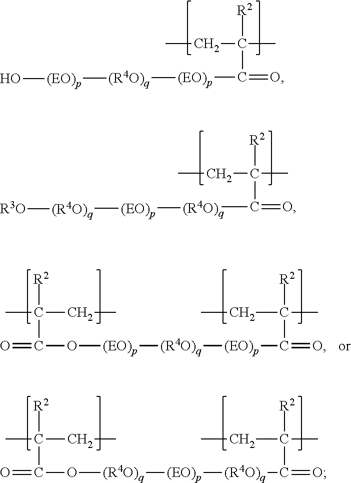

wherein R², R³, R⁴O, EO, p, and q are as defined above. In these embodiments, a ratio of first divalent units to second divalent units may be in a range from 2 to 0.1:1 (e.g., 2 to 1, 1.75 to 1, 1.5 to 1, 1.25 to 1, 1 to 1, 0.75 to 1, 0.5 to 1, or 0.25 to 1).

In some embodiments, fluorinated polymers useful in practicing the present disclosure comprise at least one divalent unit represented by formula:

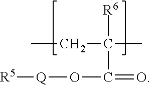

Each R⁵ is independently alkyl having up to 8 carbon atoms (e.g., methyl, ethyl, n-propyl, isopropyl, n-butyl, iso-butyl, n-pentyl, neopentyl, hexyl, heptyl, or octyl). Each R⁶ is independently hydrogen or methyl (in some embodiments, hydrogen).

In some embodiments, polymers useful for practicing the present disclosure may be represented by formula:

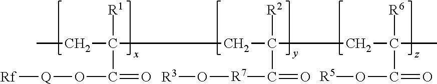

wherein Rf, R¹, Q, R², R³, R⁵, and R⁶ are as defined above, R⁷ is a poly(alkyleneoxy) segment wherein alkyleneoxy has from 2 to 4 carbon atoms, x is a value in a range from 2 to 400, y is in a range from 1 to 100, and z is in a range from 0 to 100. In this formula, the units may be distributed in any order.

Some fluorinated polymers useful for practicing the present disclosure are commercially available (e.g., from BYK Additives and Instruments, Wesel, Germany, under the trade designation “BYK-340”, from Mason Chemical Company, Arlington Heights, Ill., under the trade designation “MASURF FS-2000”, and from Ciba Specialty Chemicals, Basel, Switzerland, under the trade designation “CIBA EFKA 3600”).

Useful polymers can also be prepared, for example, by polymerizing a mixture of components typically in the presence of an initiator. By the term “polymerizing” it is meant forming a polymer or oligomer that includes at least one identifiable structural element due to each of the components. Typically the polymer that is formed has a distribution of molecular weights and compositions. The polymer may have one of many structures (e.g., a random graft copolymer or a block copolymer). The components that are useful for preparing the polymers disclosed herein include a fluorinated free-radically polymerizable monomer independently represented by formula Rf-Q-O—C(O)—C(R¹)═CH₂ or Rf—S(O)₂—N(R)—CₘH₂ₘ—O—C(O)—C(R¹)═CH₂, wherein Rf, R, R¹, Q, and m are as defined above, and a poly(alkyleneoxy) acrylate (e.g., monoacrylate, diacrylate, or a mixture thereof).

Some compounds of Formula Rf-Q-O—C(O)—C(R¹)═CH₂, are available, for example, from commercial sources (e.g., 3,3,4,4,5,5,6,6,6-nonafluorohexyl acrylate from Daikin Chemical Sales, Osaka, Japan, 3,3,4,4,5,5,6,6,6-nonafluorohexyl 2-methylacrylate from Indofine Chemical Co., Hillsborough, N.J., and 2,2,3,3,4,4,5,5-octafluoropentyl acrylate and methacrylate and 3,3,4,4,5,6,6,6-octafluoro-5-(trifluoromethyl)hexyl methacrylate from Sigma-Aldrich, St. Louis, Mo.). Others can be made by known methods (see, e.g., EP1311637 B1, published Apr. 5, 2006, the disclosure of which is incorporated herein by reference for the preparation of 2,2,3,3,4,4,4-heptafluorobutyl 2-methylacrylate). Compounds represented by formula Rf—S(O)₂—N(R)—CₘH₂ₘ—O—C(O)—C(R¹)═CH₂ can be made according to methods described in, e.g., U.S. Pat. No. 2,803,615 (Albrecht et al.) and U.S. Pat. No. 6,664,354 (Savu et al.), the disclosures of which, relating to free-radically polymerizable monomers and methods of their preparation, are incorporated herein by reference. Heptafluoropropylsulfonyl fluoride, which can be made, for example, by the methods described in Examples 2 and 3 of U.S. Pat. No. 2,732,398 (Brice et al.), the disclosure of which is incorporated herein by reference, can be a useful starting material to make compounds represented by formula Rf—S(O)₂—N(R)—CₘH₂ₘ—O—C(O)—C(R¹)═CH₂, wherein Rf is perfluoropropyl group.

Some alkyleneoxy-containing polymerizable compounds are commercially available (e.g., diethylene glycol diacrylate, tri(ethylene glycol) dimethacrylate, tri(ethylene glycol) divinyl ether, and polyoxyalkylene glycol acrylates and diacrylates (e.g., CH₂═CHC(O)O(CH₂CH₂O)₇₋₉H) available, for example, from Nippon Oil & Fats Company, Tokyo, Japan under the trade designation “BLEMMER”). Other useful alkyleneoxy-containing polymerizable compounds can be prepared by known methods, for example, combining one or two equivalents of acryloyl chloride or acrylic acid with a polyethylene glycol or a monoalkyl ether thereof having a molecular weight of about 200 to 10,000 grams per mole (e.g., those available from Dow Chemical Company, Midland, Mich., under the trade designation “CARBOWAX”) or a block copolymer of ethylene oxide and propylene oxide having a molecular weight of about 500 to 15000 grams per mole (e.g., those available from BASF Corporation, Ludwigshafen, Germany, under the trade designation “PLURONIC”). The reaction of acrylic acid with a poly(alkylene oxide) is typically carried out in the presence of an acid catalyst and a polymerization inhibitor at an elevated temperature in a suitable solvent; (see, e.g., Example 1 of U.S. Pat. No. 3,787,351 (Olson), the disclosure of which is incorporated herein by reference). In some embodiments, the alkyleneoxy-containing polymerizable compound comprises at least one of

HO-(EO)ₚ—(R⁴O)_{q}-(EO)ₚ—C(O)—C(R²)═CH₂,

R³O—(R⁴O)_{q}-(EO)ₚ—(R⁴O)_{q}—C(O)—C(R²)═CH₂,

### CH₂═C(R²)—C(O)O-(EO)ₚ—(R⁴O)_{q}-(EO)ₚ—C(O)—C(R²)═CH₂, or

CH₂═C(R²)—C(O)O—(R⁴O)_{q}-(EO)ₚ—(R⁴O)_{q}—C(O)—C(R²)═CH₂, wherein R², R³, R⁴O, EO, p, and q are as defined above.

Free radical initiators such as those widely known and used in the art may be used to initiate polymerization of the components. Examples of free-radical initiators include azo compounds (e.g., 2,2′-azobisisobutyronitrile (AIBN), 2,2′-azobis(2-methylbutyronitrile), or azo-2-cyanovaleric acid); hydroperoxides (e.g., cumene, tert-butyl or tert-amyl hydroperoxide); dialkyl peroxides (e.g., di-tert-butyl or dicumylperoxide); peroxyesters (e.g., tert-butyl perbenzoate or di-tert-butyl peroxyphthalate); diacylperoxides (e.g., benzoyl peroxide or lauryl peroxide). Useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); and acylphosphine oxide derivatives and acylphosphonate derivatives (e.g., diphenyl-2,4,6-trimethylbenzoylphosphine oxide, isopropoxyphenyl-2,4,6-trimethylbenzoylphosphine oxide, or dimethyl pivaloylphosphonate). When heated or photolyzed such free-radical initiators fragment to generate free radicals which add to ethylenically unsaturated bonds and initiate polymerization.

Polymerization reactions may be carried out in any solvent suitable for organic free-radical polymerizations. The components may be present in the solvent at any suitable concentration, (e.g., from about 5 percent to about 90 percent by weight based on the total weight of the reaction mixture). Examples of suitable solvents include aliphatic and alicyclic hydrocarbons (e.g., hexane, heptane, cyclohexane), aromatic solvents (e.g., benzene, toluene, xylene), ethers (e.g., diethyl ether, glyme, diglyme, diisopropyl ether), esters (e.g., ethyl acetate, butyl acetate), alcohols (e.g., ethanol, isopropyl alcohol), ketones (e.g., acetone, methyl ethyl ketone, methyl isobutyl ketone), sulfoxides (e.g., dimethyl sulfoxide), amides (e.g., N,N-dimethylformamide, N,N-dimethylacetamide), halogenated solvents (e.g., methylchloroform, 1,1,2-trichloro-1,2,2-trifluoroethane, trichloroethylene or trifluorotoluene), and mixtures thereof.

Polymerization can be carried out at any temperature suitable for conducting an organic free-radical reaction. Particular temperature and solvents for use can be selected by those skilled in the art based on considerations such as the solubility of reagents, the temperature required for the use of a particular initiator, and the molecular weight desired. While it is not practical to enumerate a particular temperature suitable for all initiators and all solvents, generally suitable temperatures are in a range from about 30° C. to about 200° C.

Free-radical polymerizations may be carried out in the presence of chain transfer agents. Typical chain transfer agents that may be used in the preparation of polymers described herein include hydroxyl-substituted mercaptans (e.g., 2-mercaptoethanol, 3-mercapto-2-butanol, 3-mercapto-2-propanol, 3-mercapto-1-propanol, and 3-mercapto-1,2-propanediol (i.e., thioglycerol)); amino-substituted mercaptans (e.g., 2-mercaptoethylamine); difunctional mercaptans (e.g., di(2-mercaptoethyl)sulfide); and aliphatic mercaptans (e.g., octylmercaptan, dodecylmercaptan, and octadecylmercaptan).

Adjusting, for example, the concentration and activity of the initiator, the concentration of each of the reactive monomers, the temperature, the concentration of the chain transfer agent, and the solvent using techniques known in the art can control the molecular weight of a polyacrylate copolymer.

Fluorinated polymers useful for practicing the present disclosure may contain other units, typically in weight percents up to 20, 15, 10, or 5 percent, based on the total weight of the fluorinated polymer. These units may be incorporated into the polymer chain by selecting additional components for the polymerization reaction such as alkyl acrylates and methacrylates (e.g., octadecyl methacrylate, lauryl methacrylate, butyl acrylate, isobutyl methacrylate, ethylhexyl acrylate, ethylhexyl methacrylate, methyl methacrylate, hexyl acrylate, heptyl methacrylate, cyclohexyl methacrylate, or isobornyl acrylate); allyl esters (e.g., allyl acetate and allyl heptanoate); vinyl ethers or allyl ethers (e.g., cetyl vinyl ether, dodecylvinyl ether, 2-chloroethylvinyl ether, or ethylvinyl ether); alpha-beta unsaturated nitriles (e.g., acrylonitrile, methacrylonitrile, 2-chloroacrylonitrile, 2-cyanoethyl acrylate, or alkyl cyanoacrylates); alpha-beta-unsaturated carboxylic acid derivatives (e.g., allyl alcohol, allyl glycolate, acrylamide, methacrylamide, n-diisopropyl acrylamide, or diacetoneacrylamide), styrene and its derivatives (e.g., vinyltoluene, alpha-methylstyrene, or alpha-cyanomethyl styrene); olefinic hydrocarbons which may contain at least one halogen (e.g., ethylene, propylene, isobutene, 3-chloro-1-isobutene, butadiene, isoprene, chloro and dichlorobutadiene, 2,5-dimethyl-1,5-hexadiene, and vinyl and vinylidene chloride); and hydroxyalkyl-substituted polymerizable compounds (e.g., 2-hydroxyethyl methacrylate). Other units containing pendent fluorinated groups include those derived from vinyl ethers, vinyl esters, allyl esters, vinyl ketones, styrene, vinyl amide, and acrylamides.

In some embodiments, fluorinated polymers useful for practicing the present disclosure are fluorinated polyalkyleneoxy copolymers comprising (e.g., at least 2, 3, 4, 5, 6, 7, 8, 9, or even at least 10 up to 15, 20, 25, 30, 35, 40, 45, 50 or even up to 100) first divalent units having formula:

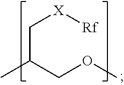

and a poly(alkyleneoxy) segment. Each Rf independently represents a fluoroalkyl group having from 1 to 10 (in some embodiments, 1 to 8, 1 to 6, 2 to 6, or 2 to 4) carbon atoms (e.g., trifluoromethyl, perfluoroethyl, 1,1,2,2-tetrafluoroethyl, 2-chlorotetrafluoroethyl, perfluoro-n-propyl, perfluoroisopropyl, perfluoro-n-butyl, 1,1,2,3,3,3-hexafluoropropyl, perfluoroisobutyl, perfluoro-sec-butyl, or perfluoro-tert-butyl, perfluoro-n-pentyl, pefluoroisopentyl, perfluorohexyl, perfluoroheptyl, or perfluorooctyl). In some embodiments, Rf is perfluorobutyl (e.g., perfluoro-n-butyl, perfluoroisobutyl, or perfluoro-sec-butyl). In some embodiments, Rf is perfluoropropyl (e.g., perfluoro-n-propyl). In some embodiments, the fluorinated alkyl group is represented by formula —CF₂—CHF—CF₃. In some embodiments, the fluorinated alkyl group is represented by formula —CF(CF₃)₂. The fluoroalkyl group may also contain a mixture of fluorinated groups (e.g., with an average of up to 4 carbon atoms).

In any of the above embodiments of fluorinated polymers and compositions according to present disclosure, each X is independently —N(R)SO₂—, —N(R)CO—, —O—CᵥH₂ᵥ—, —S—CᵥH₂ᵥ—, or —C_{w}H_{2w}—, wherein v and w are each values from 0 to 6 (i.e., 0, 1, 2, 3, 4, 5, or 6), and R is hydrogen or alkyl having 1 to 4 carbon atoms. In some embodiments, each X is independently —N(R)SO₂— or —N(R)CO—. In some of these embodiments, R is alkyl having 1 to 4 carbon atoms (e.g., methyl or ethyl). In some embodiments, X is —N(R)SO₂—, and R is methyl or ethyl. In some embodiments, each X is independently —O—CᵥH₂ᵥ— or —S—CᵥH₂ᵥ—. In some embodiments, X is —O—CᵥH₂ᵥ—. In some of these embodiments, v is 1; in other of these embodiments, v is 2. In yet other of these embodiments, v is 0. In some embodiments, X is —N(R)SO₂—, R is methyl or ethyl, and Rf¹ represents a fluoroalkyl group having from 1 to 4 carbon atoms.

The poly(alkyleneoxy) segment typically comprises a plurality of alkyleneoxy groups having from 2 to 4 (e.g., 2 to 3) carbon atoms. The plurality of alkyleneoxy groups can be a mixture of groups, for example, ethyleneoxy and propyleneoxy. The poly(alkyleneoxy) segment may have a number average molecular weight of at least 200, 300, 500, 700, or even at least 1000 grams per mole up to 2000, 4000, 5000, 8000, 10000, or even up to 15000 grams per mole. In some embodiments, the polyalkyleneoxy segment comprises moieties represented by formula:

—[EO]_{f}—[R⁴O]_{g}-[EO]_{f}—; or

—[R⁴O]_{g}-[EO]_{f}—[R⁴O]_{g}—,

wherein EO and R⁴O are as defined above; each f is independently from 1 to about 250 (e.g., 1 to 150, 1 to 100, 1 to 75, or 1 to 50); and each g is independently from 0 to about 55 (e.g., 0 to 45, 1 to 35, or 1 to 25). In some of these embodiments, each R⁴O independently represents —CH(CH₃)CH₂O— or —CH₂CH(CH₃)O—. In some embodiments, g is in a range of from 1 to 55 and the ratio f/g has a value of from at least 0.5, 0.75, 1 or 1.5 to 2.5, 2.7, 3, 4, 5, or more.

In some embodiments, fluorinated polymers useful for practicing the present disclosure are represented by formula:

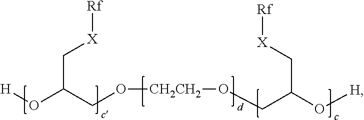

wherein X and Rf are as defined above. In these embodiments, c and c′ each independently have a value from 0 to 5, with the proviso that c+c′ is at least 2, 3, 4, 5 6, 7, 8, 9, or even at least 10; and d is from about 5 to about 50 (e.g., in a range from 5 to 10, 5 to 20, 5 to 25, 5 to 30, 5 to 40, 10 to 50, 10 to 40, 10 to 30, or 10 to 25).

In some embodiments of the fluorinated polymers useful for practicing the present disclosure, the polyalkyleneoxy segment is present in second divalent units represented by formula:

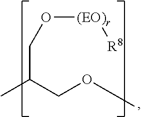

wherein EO represents —CH₂CH₂O—; each r is independently from 1 to about 150; and each R⁸ is independently hydrogen or alkyl having 1 to 4 carbon atoms. In some embodiments, each R⁸ is independently alkyl having 1 to 4 carbon atoms (e.g., methyl). Fluorinated polymers useful for practicing the present disclosure can be prepared by ring-opening polymerization of oxirane rings with pendant fluoroalkyl groups (hereinafter, “fluorinated oxiranes”). Some fluorinated oxiranes are available, for example, from commercial sources (e.g., 1H, 1H, 2H, 3H, 3H-perfluorononylene-1,2-oxide and 1H, 1H, 2H, 3H, 3H-perfluoroheptylene-1,2-oxide are available from ABCR GmbH & Co., Germany). Other fluorinated oxiranes can be prepared by conventional methods. For example, fluorinated alcohols and fluorinated sulfonamides can be treated with epichlorohydrin under basic conditions. Suitable fluorinated alcohols include trifluoroethanol, heptafluorobutanol, or nonafluorohexanol, which are commercially available, for example, from Sigma-Aldrich Corp., St. Louis, Mo. Suitable fluorinated sulfonamides include N-methylperfluorobutanesulfonamide and N-methylperfluorohexanesulfonamide, which can be prepared according to the methods described in Examples 1 and C6 of U.S. Pat. No. 6,664,534 (Savu et al.). Reactions of fluorinated alcohols or fluorinated sulfonamides with epichlorohydrin can be carried out, for example, in aqueous sodium hydroxide in the presence of a phase-transfer reagent such as methyltrialkyl(C8 to C10)ammonium chloride available from Sigma-Aldrich Corp. under the trade designation “ADOGEN 464” or in the presence of sodium hydride or sodium methoxide in a suitable solvent (e.g., tetrahydrofuran). Typically, reactions of fluorinated alcohols with epichlorohydrin are carried out at an elevated temperature (e.g., up to 40° C., 60° C., 70° C., or up to the reflux temperature of the solvent), but they may be carried out at room temperature.

Fluorinated oxiranes typically undergo ring-opening polymerization in the presence of Lewis Acid catalysts such as complexes of boron trifluoride (e.g., boron trifluoride etherate, boron trifluoride tetrahydropyran, and boron trifluoride tetrahydrofuran), phosphorous pentafluoride, antimony pentafluoride, zinc chloride, and aluminum bromide. The reaction can also be carried out in the presence of (CF₃SO₂)₂CH₂. Ring-opening polymerizations can be carried out neat or in a suitable solvent such as a hydrocarbon solvent (e.g., toluene) or a halogenated solvent (e.g., dichloromethane, carbon tetrachloride, trichloroethylene, or dichloroethane). The reactions can be carried out at or near room temperature or below (e.g., in a range from about 0° C. to 40° C.). The reactions can also be carried out above room temperature (e.g, up to 40° C., 60° C., 70° C., 90° C., or up to the reflux temperature of the solvent).

For some embodiments of the fluorinated polymers according to and/or useful for the present disclosure, the ring-opening polymerization is carried out in the presence of a monohydroxy alcohol or a diol comprising a polyalkyleneoxy segment. Such monohydroxy alcohols or diols include poly(ethylene glycols) of various molecular weights (e.g., number average molecular weights of at least 200, 300, or even 500 grams per mole up to 1000, 2000, 4000, 5000, 8000, 10000, or even 15000 grams per mole). Poly(ethylene glycols) are available, for example, from a variety of commercial sources (e.g., from Dow Chemical under the trade designation “CARBOWAX”). Block copolymers of ethylene oxide and propylene oxide having a molecular weight of about 500 to 15000 grams per mole (e.g., those available from BASF Corporation under the trade designation “PLURONIC”) are also useful.

The ring-opening polymerization may also be carried out in the presence of an oxirane comprising a polyalkyleneoxy segment. Such oxiranes can be prepared, for example, by reaction of a mono- or dihydroxy poly(ethylene glycol) with epichlorohydrin using any of the methods described above for the reaction of fluorinated alcohols or fluorinated sulfonamides with epichlorohydrin.

The ring-opening polymerization of fluorinated oxiranes can also be carried out in the presence of diamines. Reactions of fluorinated oxiranes and diamines may be carried out in the presence or absence of a Lewis Acid catalyst. Useful diamines include polyetheramines available from Huntsman Corporation, The Woodlands, Tex., under the trade designation “JEFFAMINE ED”. When such polyether diamines are used, the polyalkyleneoxy segment may comprise, for example, moieties represented by formula:

—NH—[EO]ₓ′—[R⁴O]_{y}′-[EO]ₓ′—R⁹—NH; or

—NH—[R⁴O]_{y}′-[EO]ₓ′—[R⁴O]_{y}′—R⁹—NH,

wherein EO and R⁴O are as defined above, each x′ independently is from 1 to about 50, each y′ is independently from 1 to about 10, and R⁹ is an alkylene group.

In some embodiments, the fluorinated polymer is a nonionic polymer. It may be useful in some cases to include another monomer in the ring-opening polymerization of substituted oxiranes or to convert the polymer into an anionic, cationic, or amphoteric polymer. For addition monomers and reaction conditions, see PCT Pat. App. Pub. No. WO 2009/085936 (Moore et al.), the disclosure of which is incorporated herein by reference in its entirety.

For some embodiments of fluorinated polymers useful in practicing the present disclosure, including in any of the embodiments mentioned above, the number average molecular weight of the fluorinated polymer is in a range from 1500, 2000, 2500, or even 3000 grams per mole up to 10,000, 20,000, 25,000, 30,000, 40,000, 50,000, 60,000, 70,000, 80,000, 90,000, or 100,000 grams per mole although higher molecular weights may also be useful.

For some embodiments of fluorinated polymers useful in practicing the present disclosure, the fluorinated divalent units are present in a range from 15 to 80, 20 to 80, 25 to 75, or 25 to 65 percent by weight, based on the total weight of the fluorinated polymer. In some embodiments, the polyalkyleneoxy segment is present in a range from 20 to 85, 25 to 85, 25 to 80, or 30 to 70 percent by weight, based on the total weight of the fluorinated polymer. In some embodiments each of the fluorinated divalent units and the polyalkyleneoxy segment are each present in a range from 35 to 65 percent by weight, based on the total weight of the fluorinated polymer. For some embodiments, the mole ratio of fluorinated divalent units to units containing polyalkyleneoxy moieties in the fluorinated polymer is up to 15:1, 10:1, 8:1, or 6:1 (e.g., about 4:1, 3:1, 2:1, 1:1, 1:2, or 1:3).

In some embodiments, fluorinated compounds useful for practicing the present disclosure are fluorinated polyurethanes. The term “polyurethane” refers to polymers containing at least one of urethane or urea functional groups. In some embodiments, the fluorinated polyurethane has at least two repeat units and comprises the reaction product of (a) at least one multifunctional isocyanate compound; (b) at least one polyol; (c) at least one fluorochemical monoalcohol; (d) at least one isocyanate-reactive silane; and optionally (e) at least one water-solubilizing compound comprising at least one water-solubilizing group and at least one isocyanate-reactive hydrogen containing group. In some embodiments, at least one polyamine may also be used.

In some embodiments, the fluorinated polyurethane comprises a multivalent unit comprising a segment represented by formula:

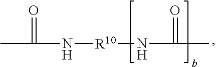

wherein b is 1 to 5 (e.g., 1 to 4, 1 to 3, or 1 to 2), and R¹⁰ is alkylene, arylene, or arylalkylene, each of which is optionally interrupted by at least one biruet, allophanate, uretdione, or isocyanurate linkage. Typically, such multivalent units arise from a condensation reaction of a multifunctional isocyanate compound comprising at least two (e.g., 2, 3, 4, or more) isocyanate groups (i.e., —NCO) linked together by alkylene, arylene, or arylalkylene, each of which is optionally attached to at least one of a biuret, an allophanate, an isocyanurate, or a uretdione. The multivalent unit is typically incorporated into the polyurethane through carbamate, urea, biuret, or allophanate linkages. In some embodiments, b is 1, and R¹⁰ is divalent alkylene, arylene, or arylalkylene (i.e., the multivalent unit is derived from a diisocyanate). In some embodiments, b is 2, and R¹⁰ is alkylene, arylene, or arylalkylene groups, which are attached to a biuret or an isocyanurate (i.e., the multivalent unit is derived from a triisocyanate). Mixtures of multivalent units may be present in the polyurethane.

In some embodiments, useful fluorinated polyurethanes are represented by formula:

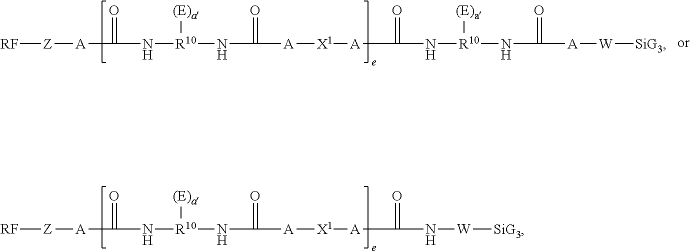

wherein RF, Z, and R¹⁰ are as defined above. X¹ is alkylene, polyalkyleneoxy, fluoroalkylene, or polyfluoroalkyleneoxy, wherein alkylene is optionally interrupted by —O— and is optionally substituted with —Si(G)₃, an ammonium group, a carboxylate, a sulfonate, a sulfate, a phosphate, or a phosphonate. In some embodiments, X¹ is alkylene or polyalkyleneoxy. In some embodiments, X¹ is alkylene that is substituted with a carboxylate group. Each a′ is 0, 1, or 2 (e.g., 0 or 1). In some embodiments, e is from 1 to 20 (e.g., 2 to 15 or 3 to 10). Each E is independently an end group represented by formula RF—Z-A—C(O)—N(H)—; (G)₃Si—W-A—C(O)—N(H)—, and (M)₁₋₂—W-A—C(O)—N(H)— (i.e., W can be substituted with one or two M groups and -A-); wherein A is —O—, —N(R¹¹)—, —S—, or —C(O)O—; G is as defined above; M is selected from the group consisting of an ammonium group, a carboxylate, a sulfonate, a sulfate, a phosphate, or a phosphonate; and each W is independently selected from the group consisting of alkylene, arylalkylene, and arylene, wherein alkylene is optionally interrupted with at least one —O—. In some embodiments, W is alkylene (e.g., having up to 6, 4, or 3 carbon atoms). In some embodiments, Z is —CⱼH₂ⱼ—, —CON(R″)CⱼH₂ⱼ—, —SO₂N(R″)CⱼH₂ⱼ—, or —CⱼH₂ⱼSO₂N(R″)CⱼH₂ⱼ—, wherein R″ is hydrogen or alkyl having up to four carbon atoms, and j is independently an integer from 1 to 6 (in some embodiments from 2 to 4).

In some embodiments, useful fluorinated polyurethanes are represented by formula

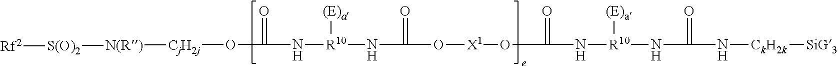

wherein each a′ is about 1; each E is as defined above with the proviso that at least one E is Rf²—S(O)₂N(R″)—CⱼH₂ⱼ—O—C(O)—N(H)—; X¹ is alkylene that is substituted with a carboxylate group; each G′ is independently alkoxy (e.g., having up to four carbon atoms) or hydroxyl; j and k are each values from 1 to 6; R¹⁰ is as defined above, each R″ is independently hydrogen or alkyl having up to four carbon atoms; and each Rf² independently represents perfluoroalkyl having from 2 to 6 (in some embodiments, 3 to 4 or 4) carbon atoms. Such fluorinated polyurethanes may be prepared, for example, by a condensation reaction of at least one multifunctional isocyanate with at least one polyol and reaction of the resulting oligomer with at least one fluorinated monoalcohol and at least one isocyanate-reactive silane.

Aromatic multifunctional isocyanate compounds useful for the preparation of fluorinated polyurethanes according to any of the above embodiments include 2,4-toluene diisocyanate (TDI), 2,6-toluene diisocyanate, an adduct of TDI with trimethylolpropane (available, for example, from Bayer Corporation, Pittsburgh, Pa. under the trade designation “DESMODUR CB”), the isocyanurate trimer of TDI (available, for example, from Bayer Corporation under the trade designation “DESMODUR IL”), diphenylmethane 4,4′-diisocyanate (MDI), diphenylmethane 2,4′-diisocyanate, 1,5-diisocyanatonaphthalene, 1,4-phenylene diisocyanate, 1,3-phenylene diisocyanate, 1-methyoxy-2,4-phenylene diisocyanate, 1-chlorophenyl-2,4-diisocyanate, and mixtures thereof Multifunctional alkylene isocyanate compounds useful for the preparation of fluorinated polyurethanes according to any of the above embodiments include 1,4-tetramethylene diisocyanate, hexamethylene 1,4-diisocyanate, hexamethylene 1,6-diisocyanate (HDI), 1,12-dodecane diisocyanate, 2,2,4-trimethyl-hexamethylene diisocyanate (TMDI), 2,4,4-trimethyl-hexamethylene diisocyanate, 2-methyl-1,5-pentamethylene diisocyanate, dimer diisocyanate, the urea of hexamethylene diisocyanate, the biuret of hexamethylene 1,6-diisocyanate (HDI) (available, for example, from Bayer Corporation under the trade designations “DESMODUR N-100” and “DESMODUR N-3200”), the isocyanurate of HDI (available, for example, from Bayer Corporation under the trade designations “DESMODUR N-3300” and “DESMODUR N-3600”), a blend of the isocyanurate of HDI and the uretdione of HDI (available, for example, from Bayer Corporation under the trade designation “DESMODUR N-3400”), dicyclohexylmethane diisocyanate (H₁₂ MDI, available, for example, from Bayer Corporation under the trade designation “DESMODUR W”), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), 1,3-bis(isocyanatomethyl)cyclohexane (H₆ XDI), 3-isocyanatomethyl-3,5,5-trimethylcyclohexyl isocyanate, and mixtures thereof.

Multifunctional arylalkylene isocyanates useful for the preparation of fluorinated polyurethanes according to any of the above embodiments include m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)-phenyl isocyanate, m-(3-isocyanatobutyl)-phenyl isocyanate, 4-(2-isocyanatocyclohexyl-methyl)-phenyl isocyanate, and mixtures thereof. The product from the reaction of m-tetramethylxylene diisocyanate with 1,1,1-tris(hydroxymethyl)propane, available, for example, from American Cyanamid, Stamford, Conn. under the trade designation “CYTHANE 3160” can also be used.

In some embodiments, fluorinated polyurethanes useful for practicing the present disclosure are prepared from a multifunctional isocyanate selected from the group consisting of HDI, 1,12-dodecane diisocyanate, isophorone diisocyanate, toluene diisocyanate, dicyclohexylmethane 4,4′diisocyanate, MDI, a biuret, uretdione, or isocyanurate thereof, and mixtures thereof.

In some embodiments, fluorinated polyurethanes useful for practicing the present disclosure are prepared from the reaction of a multifuncitional isocyanate and a polyol. Useful polyols include alkylene, arylene, arylalkylene, or polymeric groups, which are optionally interrupted with at least one ether linkage (e.g., polyalkyleneoxy compounds) or amine linkage, which have an average hydroxyl functionality of at least about 2 (e.g., up to 5, 4, or 3), and which are optionally substituted with —Si(G)₃, an ammonium group, a carboxylate, a sulfonate, a sulfate, a phosphate, or a phosphonate, wherein each G is independently as defined above. The hydroxyl groups can be primary or secondary. Mixtures of diols with polyols that have a higher average hydroxyl functionality (e.g., 2.5 to 5, 3 to 4, or 3) can also be used. Exemplary useful polyols include mono fatty acid esters of polyols (e.g., glycerol monooleate, glycerol monostearate, glycerol monoricinoleate, or C₅ to C₂₀ alkyl di-esters of pentaerythritol); castor oil; polyester diols or polyols (e.g., those available from Union Camp under the trade designation “UNIFLEX”, from Rohm and Haas Co., Philadelphia, Pa. under the trade designation “PARAPLEX U-148”, from Mobay Chemical Corp., Irvine, Calif., under the trade designation “MULTRON”, or those derived from dimer acids or dimer diols and available, for example, from Uniqema, Gouda, Netherlands, under the trade designations “PRIPLAST” or “PRIPOL”; hydroxy-terminated polylactones (e.g., polycaprolactone polyols, for example, with number average molecular weights in the range of about 200 to about 2000 available, for example, from Union Carbide Corp., Danbury, Conn., under the trade designation “TONE”, for example, grades 0201, 0210, 0301, and 0310); hydroxy-terminated polyalkadienes (e.g., hydroxyl-terminated polybutadienes, for example, those available from Elf Atochem, Philadelphia, Pa., under the trade designation “POLY BD”); alkylene diols (e.g., 1,2-ethanediol, 1,2-propanediol, 3-chloro-1,2-propanediol, 1,3-propanediol, 1,3-butanediol, 1,4-butanediol, 2-methyl-1,3-propanediol, 2,2-dimethyl-1,3-propanediol (neopentylglycol), 2-ethyl-1,3-propanediol, 2,2-diethyl-1,3-propanediol, 1,5-pentanediol, 2-ethyl-1,3-pentanediol, 2,2,4-trimethyl-1,3-pentanediol, 3-methyl-1,5-pentanediol, 1,2-, 1,5-, and 1,6-hexanediol, 2-ethyl-1,6-hexanediol, bis(hydroxymethyl)cyclohexane, 1,8-octanediol, bicyclo-octanediol, 1,10-decanediol, tricyclo-decanediol, norbornanediol, and 1,18-dihydroxyoctadecane); polyhydroxyalkanes (e.g., glycerol, trimethylolethane, trimethylolpropane, 2-ethyl-2-(hydroxymethyl)-1,3-propanediol, 1,2,6-hexanetriol, pentaerythritol, quinitol, mannitol, and sorbitol); Bisphenol A ethoxylate, Bisphenol A propyloxylate, and Bisphenol A propoxylate/ethoxylate (available from Sigma-Aldrich, Milwaukee, Wis.); polytetramethylene ether glycols available, for example, from Quaker Oats Company, Chicago, Ill., under the trade designation “POLYMEG”, for example, grades 650 and 1000) and polyether polyols available, for example, from E.I. duPont de Nemours, Wilmington, Del., under the trade designation “TERATHANE”); polyoxyalkylene tetrols having secondary hydroxyl groups available, for example, from Wyandotte Chemicals Corporation, Wyandotte, Mich., under the trade designation “PeP”, for example grades 450, 550, and 650; polycarbonate diols (e.g., a hexanediol carbonate with Mₙ=900 available, for example, from PPG Industries, Inc., Pittsburgh, Pa., under the trade designation “DURACARB 120”, aromatic diols (e.g., N,N-bis(hydroxyethyl)benzamide, 4,4′-bis(hydroxymethyl)diphenylsulfone, 1,4-benzenedimethanol, 1,3-bis(2-hydroxyethyoxy)benzene, 1,2-dihydroxybenzene, resorcinol, 1,4-dihydroxybenzene, 3,5-, 2,6-, 2,5-, and 1,6-, 2,6-, 2,5-, and 2,7-dihydroxynaphthalene, 2,2′- and 4,4′-biphenol, 1,8-dihydroxybiphenyl, 2,4-dihydroxy-6-methyl-pyrimidine, 4,6-dihydroxypyrimidine, 3,6-dihydroxypyridazine, bisphenol A, 4,4′-ethylidenebisphenol, 4,4′-isopropylidenebis(2,6-dimethylphenol), bis(4-hydroxyphenyl)methane, 1,1-bis(4-hydroxyphenyl)-1-phenylethane (bisphenol C), 1,4-bis(2-hydroxyethyl)piperazine, bis(4-hydroxyphenyl) ether; and diols and polyols containing another functional group (e.g., bis(hydroxymethyl)propionic acid, 2,4-dihydroxybenzoic acid, N,N-bis(2-hydroxyethyl)-3-aminopropyltriethoxysilane, and bicine).

In some embodiments, useful polyols comprise alkyleneoxy groups, which may be useful, for example, for increasing the water-solubility of the compounds disclosed herein. Useful alkyleneoxy-containing polyols include di and polyalkylene glycols (e.g., di(ethylene glycol), tri(ethylene glycol), tetra(ethylene glycol), dipropylene glycol, diisopropylene glycol, tripropylene glycol, 1,11-(3,6-dioxaundecane)diol, 1,14-(3,6,9,12-tetraoxatetradecane)diol, 1,8-(3,6-dioxa-2,5,8-trimethyloctane)diol, or 1,14-(5,10-dioxatetradecane)diol); polyoxyethylene, polyoxypropylene, and ethylene oxide-terminated polypropylene glycols and triols of molecular weights from about 200 to about 2000 (e.g., available from Union Carbide Corp. under the trade designation “CARBOWAX”, poly(propylene glycol) available, for example, from Lyondell Chemical Company, Houston, Tex., under the trade designation “PPG-425”); block copolymers of poly(ethylene glycol) and poly(propylene glycol) available from BASF Corporation, Mount Olive, N.J., under the trade designation “PLURONIC”.

Other alkyleneoxy-containing compounds may be useful co-reactants with multifunctional isocyanates to prepare fluorinated polyurethanes useful for practicing the present disclosure. For example, diamino terminated poly(alkylene oxide) compounds (e.g., those available from Huntsman Corp., The Woodlands, Tex. under the trade designations “JEFFAMINE ED” or “JEFFAMINE EDR-148”) and poly(oxyalkylene) thiols may be used.

Useful fluorinated monoalcohols include, for example, 2-(N-methylperfluorobutanesulfonamido)ethanol; 2-(N-ethylperfluorobutanesulfonamido)ethanol; 2-(N-methylperfluorobutanesulfonamido)propanol; N-methyl-N-(4-hydroxybutyl)perfluorohexanesulfonamide; 1,1,2,2-tetrahydroperfluorooctanol; 1,1-dihydroperfluorooctanol; C₆F₁₃CF(CF₃)CO₂C₂H₄CH(CH₃)OH; n-C₆F₁₃CF(CF₃)CON(H)CH₂CH₂OH; C₄F₉OC₂F₄OCF₂CH₂OCH₂CH₂OH; C₃F₇CON(H)CH₂CH₂OH; 1,1,2,2,3,3-hexahydroperfluorodecanol; C₃F₇O(CF(CF₃)CF₂O)₁₋₃₆CF(CF₃)CH₂OH; CF₃O(CF₂CF₂O)₁₋₃₆CF₂CH₂OH; and mixtures thereof In some embodiments, the fluorinated monoalcohol is represented by the formula HO—(CⱼH₂ⱼ)N(R″)S(O)₂—Rf², wherein j, R″, and Rf² are as defined above. An end-group of the formula -A¹-W—SiG₃ can be incorporated into a fluorinated urethane oligomer by carrying out the polymerization reaction (e.g., as described above) in the presence of a silane of formula HA-W—SiG₃ (in some embodiments, H₂N—(CH₂)ₙ—SiG₃). Useful silanes of formula HA-W—SiG₃ include

H₂NCH₂CH₂CH₂Si(OC₂H₅)₃; H₂NCH₂CH₂CH₂Si(OCH₃)₃;

H₂NCH₂CH₂CH₂Si(O—N═C(CH₃)(C₂H₅))₃; HSCH₂CH₂CH₂Si(OCH₃)₃;

HO(C₂H₄O)₃C₂H₄N(CH₃)(CH₂)₃Si(OC₄H₉)₃; H₂NCH₂C₆H₄CH₂CH₂Si(OCH₃)₃;

HSCH₂CH₂CH₂Si(OCOCH₃)₃; HN(CH₃)CH₂CH₂Si(OCH₃)₃;

HSCH₂CH₂CH₂SiCH₃(OCH₃)₂; (H₃CO)₃SiCH₂CH₂CH₂NHCH₂CH₂CH₂Si(OCH₃)₃;

HN(CH₃)C₃H₆Si(OCH₃)₃; CH₃CH₂OOCCH₂CH(COOCH₂CH₃)HNC₃H₆Si(OCH₂CH₃)₃;

C₆H₅NHC₃H₆Si(OCH₃)₃; H₂NC₃H₆SiCH₃(OCH₂CH₃)₂;

HOCH(CH₃)CH₂OCONHC₃H₆Si(OCH₂CH₃)₃;

(HOCH₂CH₂)₂NCH₂CH₂CH₂Si(OCH₂CH₃)₃; and mixtures thereof.

Typically, condensation reactions useful for preparing fluorinated polyurethanes are run in the presence of a catalyst, for example, a tin II or tin IV salt (e.g., dibutyltin dilaurate, stannous octanoate, stannous oleate, tin dibutyldi-(2-ethyl hexanoate), tin (II) 2-ethyl hexanoate, and stannous chloride) or a tertiary amine (e.g., triethylamine, tributylamine, triethylenediamine, tripropylamine, bis(dimethylaminoethyl) ether, ethyl morpholine, 2,2′-dimorpholinodiethyl ether, 1,4-diazabicyclo[2.2.2]octane (DABCO), and 1,8-diazabicyclo[5.4.0.]undec-7-ene (DBU). In some embodiments, a tin salt is used. The amount of catalyst present will depend on the particular reaction. Generally, however, suitable catalyst concentrations are from about 0.001 percent to about 10 percent (in some embodiments, about 0.1 percent to about 5 percent or about 0.1 to about 1 percent) by weight based on the total weight of the reactants. Typically, the reaction will be carried out such that all or almost all (e.g., greater than 90, 95, 98, 99, or 99.5 percent) isocyanate groups have been reacted, resulting in a product that is essentially free of isocyanate groups.

The condensation reaction useful for the preparation of fluorinated polyurethanes is typically carried out under dry conditions in common, non-protic organic solvents (e.g., ethyl acetate, acetone, methyl isobutyl ketone, methyl ethyl ketone, and toluene) and fluorinated solvents (e.g., hydrofluoroethers and trifluorotoluene). Suitable reaction temperatures can be determined by those skilled in the art based on the particular reagents, solvents, and catalysts being used. Generally suitable reaction temperatures are between about room temperature and about 120° C. (e.g., 30° C. to 100° C., 40° C. to 90° C. to 80° C.). Generally the reaction is carried out such that between 1 and 100 percent (e.g., from 5 to 60, 10 to 50, or 10 to 40 percent) of the isocyanate groups of the multifunctional isocyanate compound or mixture of multifunctional isocyanate compounds is reacted with the fluorinated alcohol or amine. The remainder of the isocyanate groups is reacted with one or more of the components described above. For example, an oligomeric compound may be obtained by reacting 10 to 30 percent of the isocyanate groups with a fluorinated alcohol, reacting 10 to 30 percent of the isocyanate groups with a silane compound represented by formula (G)₃Si—W-AH, and reacting 0 to 40 percent of the isocyanate groups with water or a fluorinated alcohol or amine, an aliphatic alcohol, or a compound represented by formula (M)₁₋₂-W-AH. When a compound represented by formula (M)₁₋₂-W-AH is used, typically the ratio of the multifunctional isocyanate compound to the compound represented by formula (M)₁₋₂-W-AH is from about 3:1 to about 16:1 (e.g., 5:1 to about 11:1). The order of the addition of components can be changed as would be understood by a person of skill in the art.

In some embodiments, the multifunctional isocyanate compound is combined with a fluorinated or non-fluorinated polyol in addition to the fluorinated compound represented by formula RF—Z-AH. A mixture of polyols can be used instead of a single polyol. When the multifunctional isocyanate compound is a triisocyanate, the polyol is typically a diol to prevent undesired gelation. The resulting isocyanate functional oligomers are then further reacted with a fluorinated compound represented by formula RF—Z-AH and at least one of a fluorinated alcohol, an aliphatic alcohol, a silane compound represented by formula (G)₃Si—W-AH, or a compound represented by formula (M)₁₋₂-W-AH. End groups represented by formula RF—Z-A¹- are thereby bonded to the isocyanate functional oligomers. In some embodiments, a compound represented by formula G)₃Si—W-AH (e.g., an aminosilane) is used in the reaction mixture.

Exemplary reaction conditions and other components useful for preparing useful fluorinated polyurethanes are described in U.S. Pat. No. 6,646,088 (Fan et al.), the disclosure of which is incorporated herein by reference in its entirety.

In some embodiments, the fluorinated compound useful for practicing the present disclosure is a fluorinated silane. Useful fluorinated silanes include a fluorinated silane (available, for example, from Daikin Industries, Inc., New York, NY under the trade designation “OPTOOL DSX”); tridecafluorooctyl functional silanes (available, for example, from United Chemical Technologies, Inc., Bristol, Pa. under the trade designation “PETRARCH” (e.g., grades “T2492” and “T2494”); polymeric silanes as described in U.S. Pat. No. 6,689,854 (Fan et al.); and silanes described in U.S. Pat. App. Pub. No. 2008/0113882 (Arco et al.), the disclosures of which, relating to the structures of silanes, are incorporated herein by reference.

In some embodiments, the fluorinated compound useful for practicing the present disclosure is a fluorinated phosphate or phosphonate such as those described in U.S. Pat. App. Ser. No. 61/138744 (Dams et al.), filed Dec. 18, 2008 and incorporated herein by reference in its entirety. In some embodiments, the fluorinated compound useful for practicing the present disclosure is a fluorinated epoxide such as those described in PCT Pat. App. Pub. No. WO 2009/148829 (Sharma et al.), the disclosure of which is incorporated herein by reference in its entirety.

Typically, in treatment compositions according to the present disclosure and/or useful for practicing any of the methods described herein, the fluorinated compound is present in the treatment composition at at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.5, 1, 1.5, 2, 3, 4, or 5 percent by weight, up to 5, 6, 7, 8, 9, or 10 percent by weight, based on the total weight of the composition. For example, the amount of the fluorinated compound in the treatment composition may be in a range of from 0.01 to 10, 0.1 to 10, 0.1 to 5, 1 to 10, or even in a range from 1 to 5 percent by weight, based on the total weight of the composition. Lower and higher amounts of the fluorinated compound in the treatment composition may also be used, and may be desirable for some applications.

Treatment compositions according to and/or useful in practicing the present disclosure comprise solvent. Examples of useful solvents for any of these methods include organic solvents, water, easily gasified fluids (e.g., ammonia, low molecular weight hydrocarbons, and supercritical or liquid carbon dioxide), and combinations thereof. In some embodiments of treatment compositions disclosed herein, the solvent comprises a ketone, ether, or ester having from 4 to 10 (e.g., 5 to 10, 6 to 10, 6 to 8, or 6) carbon atoms or a hydrofluoroether or hydrofluorocarbon. In some of these embodiments, the solvent comprises two different ketones, each having 4 to 10 carbon atoms (e.g., any combination of 2-butanone, 4-methyl-2-pentanone, 3-methyl-2-pentanone, 2-methyl-3-pentanone, and 3,3-dimethyl-2-butanone). In some embodiments, the solvent further comprises at least one of water or a monohydroxy alcohol having up to 4 carbon atoms (e.g., methanol, ethanol, n-propanol, isopropanol, 1-butanol, 2-butanol, isobutanol, and t-butanol). Useful ethers include diethyl ether, diisopropyl ether, tetrahydrofuran, p-dioxane, and tert-butyl methyl ether. Useful esters include ethyl acetate, propyl acetate, and butyl acetate. Useful hydrofluoroethers may be represented by the general formula Rf³—[O—Rdₐ, wherein a is an integer from 1 to 3; Rf³ is a perfluoroalkyl or di- or trivalent perfluoroalkylene, each of which may be interrupted with at least one —O—; and Rₕ is an alkyl group optionally interrupted with at least one —O—. Numerous hydrofluoroethers of this type are disclosed in U.S. Pat. No. 6,380,149 (Flynn et al.), the disclosure of which is incorporated herein by reference. In some embodiments, the hydrofluoroether is methyl perfluorobutyl ether or ethyl perfluorobutyl ether. Useful hydrofluoroethers also include hydrofluoroethers available, for example, from 3M Company, St. Paul, Minn. under the trade designations “HFE-7100” and “HFE-7200”.

Typically, the solvents disclosed herein are capable of solubilizing more brine (i.e., no salt precipitation occurs) in the presence of a fluorinated compound than methanol, ethanol, propanol, butanol, or acetone alone. Also, the solvents disclosed herein are typically capable of solubilizing more brine in the presence of a fluorinated compound than solvents comprising glycols or glycol ethers. In some embodiments of the methods disclosed herein, the solvent comprises up to 65, 50, 40, 30, 20, or 10 percent by weight of a monohydroxy alcohol having up to 6 (in some embodiments, 4 or 3) carbon atoms, based on the total weight of the treatment composition. In some embodiments, the solvent comprises water in a range from 2 to 40 (in some embodiments, 5 to 40) percent by weight, based on the total weight of the treatment composition. In some embodiments, the solvent comprises at least about 2, 4, 5, 6, 7, 8, or 9 percent by weight water, based on the total weight of the treatment composition. In some embodiments, the solvent comprises up to about 50, 45, 40, or 35 percent by weight water, based on the total weight of the treatment composition. In some embodiments, the solvent comprises ketone (e.g., one or two ketones) in a range from 10 to 75, 15 to 60, or 15 to 55 percent by weight, based on the total weight of the treatment composition. In some embodiments, the solvent comprises at least about 10, 12, 14, 16, or 18 percent by weight ketone, based on the total weight of the treatment composition. In some embodiments, the solvent comprises up to about 75, 70, 65, 60, or 55 percent by weight ketone, based on the total weight of the treatment composition.

The amount of solvent typically varies inversely with the amount of other components in compositions according to and/or useful in practicing the present disclosure. For example, based on the total weight of the composition the solvent may be present in the composition in an amount of from at least 50, 60, or 75 percent by weight or more up to 60, 70, 80, 90, 95, 98, or 99 percent by weight, or more.

The ingredients for treatment compositions described herein including fluorinated compounds, solvents, and optionally water can be combined using techniques known in the art for combining these types of materials, including using conventional magnetic stir bars or mechanical mixer (e.g., in-line static mixer and recirculating pump).

Without wanting to be bound by theory, it is believed that when treatment compositions disclosed herein encounter brine, a water-rich phase will separate from a phase rich in the fluorinated compound. That is, the fluorinated compound may preferentially partition into a solvent with relatively low water solubility. When this partitioning takes place, the water-rich phase typically has a higher concentration of dissolved salts from the brine, and the phase containing the fluorinated compound has a lower concentration of dissolved salts.

The methods disclosed herein are typically useful for hydrocarbon-bearing formations having brine with high levels of total dissolved salt. In some embodiments, the salinity of the brine is greater than 100,000 ppm (e.g., greater than 110,000, 125,000, 130,000, 150,000, or 200,000 ppm) total dissolved salt. The methods disclosed herein are also typically useful for hydrocarbon-bearing formations having brine with ions that are otherwise poorly soluble in organic solvents. In some embodiments, the brine composition comprises at least one of sulfate or borate ions. Other salt that may be present in the brine include sodium chloride, calcium chloride, strontium chloride, magnesium chloride, potassium chloride, ferric chloride, ferrous chloride, and hydrates thereof. In some embodiments of the methods disclosed herein, the amount of the brine composition in the mixture (i.e., the mixture of the treatment composition and the brine composition) is in a range from 5 to 95 percent by weight (e.g., at least 10, 20, 30, 35, 40, 45, 50, 55, 60, or at least 70 percent by weight) based on the total weight of the mixture. The methods disclosed herein are typically useful for hydrocarbon-bearing formations having large quantities of brine. Methods disclosed herein may also be advantageous because at a given temperature lower amounts of treatment compositions disclosed herein will typically be required to treat a hydrocarbon-bearing formation than compositions having lower brine solubility (i.e., compositions that can dissolve a relatively lower amount of brine) but containing the same fluorinated compound at the same concentration.

The brine present in the hydrocarbon-bearing formation may be from a variety of sources including at least one of connate water, flowing water, mobile water, immobile water, residual water from a fracturing operation or from other downhole fluids, or crossflow water (e.g., water from adjacent perforated formations or adjacent layers in the formations). The brine may cause water blocking in the hydrocarbon-bearing formation.

For the methods disclosed herein, a mixture of an amount of brine and the treatment composition is substantially free of precipitated solid (e.g., salts, asphaltenes, or fluorinated compounds). As used herein, the term “substantially free of precipitated solid” refers to an amount of precipitated solid that does not interfere with the ability of the fluorinated polymer to increase the gas permeability of the hydrocarbon-bearing formation. In some embodiments, “substantially free of precipitated solid” means that no precipitated solid is visually observed. In some embodiments, “substantially free of precipitated solid” is an amount of solid that is less than 5% by weight higher than the solubility product of the solid at a given temperature and pressure.

Methods according to the present disclosure include receiving (e.g., obtaining or measuring) data comprising the temperature and the brine composition (including the brine saturation level and components of the brine) of a selected hydrocarbon-bearing formation. These data can be obtained or measured using techniques well known to one of skill in the art.

Phase behavior of a mixture of the brine composition and the treatment composition can be evaluated before treating the hydrocarbon-bearing formation by obtaining a sample of the brine from the hydrocarbon-bearing formation and/or analyzing the composition of the brine from the hydrocarbon-bearing formation and preparing an equivalent brine having the same or similar composition to the composition of the brine in the formation. The brine composition and the treatment composition can be combined (e.g., in a container) at the temperature and then mixed together (e.g., by shaking or stirring). The mixture is then maintained at the temperature for a certain time period (e.g., 15 minutes), removed from the heat, and immediately visually evaluated to see if at least two separate transparent layers are formed or if cloudiness or precipitation occurs. The phase behavior of the composition and the brine can be evaluated over an extended period of time (e.g., 1 hour, 12 hours, 24 hours, or longer) to determine if any phase separation, precipitation, or cloudiness is observed. By adjusting the relative amounts of brine (e.g., equivalent brine) and the treatment composition, it is possible to determine the maximum brine uptake capacity (above which precipitation occurs) of the treatment composition at a given temperature. Varying the temperature at which the above procedure is carried out typically results in a more complete understanding of the suitability of treatment compositions for a given well.

In addition to using a phase behavior evaluation, it is also contemplated that one may be able to obtain the compatibility information, in whole or in part, by computer simulation or by referring to previously determined, collected, and/or tabulated information (e.g., in a handbook, table, or a computer database). In some embodiments, the selecting a treatment composition comprises consulting a table of compatibility data between brines and treatment compositions at different temperatures.

Whether the mixture of the brine composition and the treatment composition is substantially free of precipitated solid and separates into at least two separate transparent liquid layers at the temperature of the hydrocarbon-bearing formation can depend on many variables (e.g., concentration of the fluorinated compound, solvent composition, brine concentration and composition, hydrocarbon concentration and composition, and the presence of other components (e.g., surfactants or scale inhibitors)). In some embodiments, the treatment composition further comprises a scale inhibitor. Useful scale inhibitors include polyacrylic acid, ethylenediaminetetraacetic acid, hydrochloric acid, formic acid, citric acid, acetic acid, phosphonates, phosphonic acids (e.g., 2-phosphono-1,2,4-butanetricaboxylic acid, amino(trimethylene) phosphonic acid), diphosphonic acid, and phosphate esters. In some embodiments, the scale inhibitor is polyacrylic acid.

In some embodiments of the treatment methods disclosed herein, the hydrocarbon-bearing formation has both liquid hydrocarbons and gas, and the hydrocarbon-bearing formation has at least a gas permeability that is increased after the hydrocarbon-bearing formation is treated with the treatment composition. In some embodiments, the gas permeability after treating the hydrocarbon-bearing formation with the composition is increased by at least 5 percent (in some embodiments, by at least 10, 15, 20, 30, 40, 50, 60, 70, 80, 90, or 100 percent or more) relative to the gas permeability of the formation before treating the formation with the composition. In some embodiments, the gas permeability is a gas relative permeability. In some embodiments, the liquid (e.g., oil or condensate) permeability in the hydrocarbon-bearing formation is also increased (in some embodiments, by at least 5, 10, 15, 20, 30, 40, 50, 60, 70, 80, 90, or 100 percent or more) after treating the formation with the treatment composition.

The hydrocarbon-bearing formation may have both gas and liquid hydrocarbons and may have gas condensate, black oil, or volatile oil. The hydrocarbons may comprise, for example, at least one of methane, ethane, propane, butane, pentane, hexane, heptane, octane, nonane, decane, or higher hydrocarbons. The term “black oil” refers to the class of crude oil typically having gas-oil ratios (GOR) less than about 2000 scf/stb (356 m³/m³). For example, a black oil may have a GOR in a range from about 100 (18), 200 (36), 300 (53), 400 (71), or even 500 scf/stb (89 m³/m³) up to about 1800 (320), 1900 (338), or 2000 scf/stb (356 m³/m³). The term “volatile oil” refers to the class of crude oil typically having a GOR in a range between about 2000 and 3300 scf/stb (356 and 588 m³/m³). For example, a volatile oil may have a GOR in a range from about 2000 (356), 2100 (374), or 2200 scf/stb (392 m³/m³) up to about 3100 (552), 3200 (570), or 3300 scf/stb (588 m³/m³). In some embodiments, the at least one of solvent or water (in the composition) at least partially solubilizes or at least partially displaces the liquid hydrocarbons in the hydrocarbon-bearing formation.

Generally, for the treatment methods disclosed herein, the amounts of the fluorinated compound and solvent (and type of solvent) is dependent on the particular application since conditions typically vary between wells, at different depths of individual wells, and even over time at a given location in an individual well. Advantageously, treatment methods according to the present disclosure can be customized for individual wells and conditions.

The hydrocarbon-bearing formations that may be treated according to the present disclosure may be siliciclastic (e.g., shale, conglomerate, diatomite, sand, and sandstone) or carbonate (e.g., limestone or dolomite) formations. In some embodiments, the hydrocarbon-bearing formation is predominantly sandstone (i.e., at least 50 percent by weight sandstone). In some embodiments, the hydrocarbon-bearing formation is predominantly limestone (i.e., at least 50 percent by weight limestone).

Methods according to the present disclosure may be practiced, for example, in a laboratory environment (e.g., on a core sample (i.e., a portion) of a hydrocarbon-bearing formation or in the field (e.g., on a subterranean hydrocarbon-bearing formation situated downhole). Typically, the methods disclosed herein are applicable to downhole conditions having a pressure in a range from about 1 bar (100 kPa) to about 1000 bars (100 MPa) and have a temperature in a range from about 100° F. (37.8° C.) to 400° F. (204° C.) although the methods are not limited to hydrocarbon-bearing formations having these conditions. Those skilled in the art, after reviewing the instant disclosure, will recognize that various factors may be taken into account in practice of the any of the disclosed methods including the ionic strength of the brine, pH (e.g., a range from a pH of about 4 to about 10), and the radial stress at the wellbore (e.g., about 1 bar (100 kPa) to about 1000 bars (100 MPa)).

In the field, treating a hydrocarbon-bearing formation with a composition described herein can be carried out using methods (e.g., by pumping under pressure) well known to those skilled in the oil and gas art. Coil tubing, for example, may be used to deliver the treatment composition to a particular geological zone of a hydrocarbon-bearing formation. In some embodiments of practicing the methods described herein it may be desirable to isolate a geological zone (e.g., with conventional packers) to be treated with the composition.

Methods described herein are useful, for example on both existing and new wells. In some embodiments, it may be desirable to allow for a shut-in time after treatment compositions described herein contact hydrocarbon-bearing formations. Exemplary shut-in times include a few hours (e.g., 1 to 12 hours), about 24 hours, or even a few (e.g., 2 to 10) days. After the treatment composition has been allowed to remain in place for a selected time, the solvents present in the composition may be recovered from the formation by simply pumping fluids up tubing in a well as is commonly done to produce fluids from a formation.

In some embodiments of treatment methods according to the present disclosure, the method comprises treating the hydrocarbon-bearing formation with a fluid prior to treating the hydrocarbon-bearing formation with the composition. In some embodiments, the fluid at least one of at least partially solubilizes or at least partially displaces the brine in the hydrocarbon-bearing formation. In some embodiments, the fluid at least partially solubilizes the brine. In some embodiments, the fluid at least partially displaces the brine. In some embodiments, the fluid at least one of at least partially solubilizes or displaces liquid hydrocarbons in the hydrocarbon-bearing formation. In some embodiments, the fluid is substantially free of fluorinated compounds. The term “substantially free of fluorinated compounds” refers to fluid that may have a fluorinated compound in an amount insufficient for the fluid to have a cloud point (e.g., when it is below its critical micelle concentration). A fluid that is substantially free of fluorinated compounds may be a fluid that has a fluorinated compound but in an amount insufficient to alter the wettability of, for example, a hydrocarbon-bearing formation under downhole conditions. A fluid that is substantially free of fluorinated compounds includes those that have a weight percent of such polymers as low as 0 weight percent. The fluid may be useful for decreasing the concentration of at least one of the salts present in the brine prior to introducing the composition to the hydrocarbon-bearing formation. The change in brine composition may change the results of a phase behavior evaluation (e.g., the combination of a treatment composition with a first brine prior to the fluid preflush may result in salt precipitation while the combination of the treatment composition with the brine after the fluid preflush may result in no salt precipitation and the formation of at least two separate transparent liquid layers.)

In some embodiments of treatment methods disclosed herein, the fluid comprises at least one of toluene, diesel, heptane, octane, or condensate. In some embodiments, the fluid comprises at least one of water, methanol, ethanol, or isopropanol. In some embodiments, the fluid comprises any of the solvents or solvent combinations mentioned above. In some embodiments, the fluid comprises at least one of nitrogen, carbon dioxide, or methane. In some embodiments, the fluid comprises a scale inhibitor (e.g., any of the scale inhibitors described above.)

In some embodiments of the methods disclosed herein, the hydrocarbon-bearing formation has at least one fracture. In some embodiments, fractured formations have at least 2, 3, 4, 5, 6, 7, 8, 9, or 10 or more fractures. As used herein, the term “fracture” refers to a fracture that is man-made. In the field, for example, fractures are typically made by injecting a fracturing fluid into a subterranean geological formation at a rate and pressure sufficient to open a fracture therein (i.e., exceeding the rock strength).

In some embodiments of the methods disclosed herein, wherein treating the formation with the treatment composition provides an increase in at least one of the gas permeability or the liquid permeability of the formation, the formation is a non-fractured formation (i.e., free of man-made fractures). Advantageously, treatment methods disclosed herein typically provide an increase in at least one of the gas permeability or the hydrocarbon liquid permeability of the formation without fracturing the formation. In some embodiments, hydrocarbon-bearing formations that may be treated according to the methods disclosed herein (e.g., limestone or carbonate formations) have natural fractures. Natural fractures may be formed, for example, as part of a network of fractures. Typically, fracturing a hydrocarbon-bearing formation refers to intentionally fracturing the formation after the wellbore is drilled. The term “free of manmade fractures” refers to the hydrocarbon-bearing formation being free of fractures made by this process. Therefore, in some embodiments, the method does not include intentionally fracturing the hydrocarbon-bearing formation.

In some embodiments of the treatment methods and articles disclosed herein, wherein the hydrocarbon-bearing formation has at least one fracture, the fracture has a plurality of proppants therein. Prior to delivering the proppants into a fracture, the proppants may be treated with a fluorinated compound or may be untreated (e.g., may comprise less than 0.1% by weight fluorinated compound, based on the total weight of the plurality of proppants). In some embodiments, the fluorinated compound in the treatment composition is adsorbed on at least a portion of the plurality of proppants.

Exemplary proppants known in the art include those made of sand (e.g., Ottawa, Brady or Colorado Sands, often referred to as white and brown sands having various ratios), resin-coated sand, sintered bauxite, ceramics (i.e., glasses, crystalline ceramics, glass-ceramics, and combinations thereof), thermoplastics, organic materials (e.g., ground or crushed nut shells, seed shells, fruit pits, and processed wood), and clay. Sand proppants are available, for example, from Badger Mining Corp., Berlin, Wis.; Borden Chemical, Columbus, Ohio; and Fairmont Minerals, Chardon, Ohio. Thermoplastic proppants are available, for example, from the Dow Chemical Company, Midland, Mich.; and BJ Services, Houston, Tex. Clay-based proppants are available, for example, from CarboCeramics, Irving, Tex.; and Saint-Gobain, Courbevoie, France. Sintered bauxite ceramic proppants are available, for example, from Borovichi Refractories, Borovichi, Russia; 3M Company, St. Paul, Minn.; CarboCeramics; and Saint Gobain. Glass bubble and bead proppants are available, for example, from Diversified Industries, Sidney, British Columbia, Canada; and 3M Company.

In some embodiments of methods of treating fractured formations, the proppants form packs within a formation and/or wellbore. Proppants may be selected to be chemically compatible with the solvents and compositions described herein. The term “proppant” as used herein includes fracture proppant materials introducible into the formation as part of a hydraulic fracture treatment and sand control particulate introducible into the wellbore/formation as part of a sand control treatment such as a gravel pack or frac pack.

In some embodiments, methods according to the present disclosure include treating the hydrocarbon-bearing formation with the treatment composition at least one of during fracturing or after fracturing the hydrocarbon-bearing formation.

In some embodiments of methods of treating fractured formations, the amount of the treatment composition introduced into the fractured formation is based at least partially on the volume of the fracture(s). The volume of a fracture can be measured using methods that are known in the art (e.g., by pressure transient testing of a fractured well). Typically, when a fracture is created in a hydrocarbon-bearing subterranean formation, the volume of the fracture can be estimated using at least one of the known volume of fracturing fluid or the known amount of proppant used during the fracturing operation. Coil tubing, for example, may be used to deliver the treatment composition to a particular fracture. In some embodiments, in practicing the methods disclosed herein it may be desirable to isolate the fracture (e.g., with conventional packers) to be treated with the treatment composition.

In some embodiments, wherein the formation treated according to the methods described herein has at least one fracture, the fracture has a conductivity, and after the composition treats at least one of the fracture or at least a portion of the plurality of proppants, the conductivity of the fracture is increased (e.g., by 25, 50, 75, 100, 125, 150, 175, 200, 225, 250, 275, or by 300 percent).

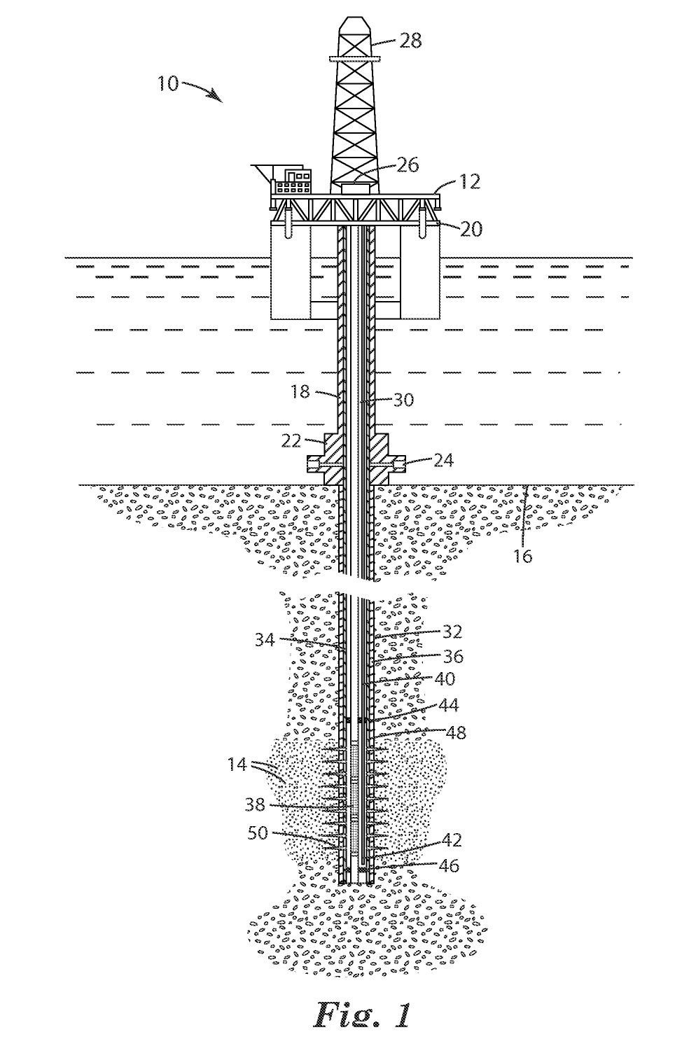

Referring to FIG. 1, an exemplary offshore oil platform is schematically illustrated and generally designated 10. Semi-submersible platform 12 is centered over submerged hydrocarbon-bearing formation 14 located below sea floor 16. Subsea conduit 18 extends from deck 20 of platform 12 to wellhead installation 22 including blowout preventers 24. Platform 12 is shown with hoisting apparatus 26 and derrick 28 for raising and lowering pipe strings such as work string 30.

Wellbore 32 extends through the various earth strata including hydrocarbon-bearing formation 14. Casing 34 is cemented within wellbore 32 by cement 36. Work string 30 may include various tools including, for example, sand control screen assembly 38 which is positioned within wellbore 32 adjacent to hydrocarbon-bearing formation 14. Also extending from platform 12 through wellbore 32 is fluid delivery tube 40 having fluid or gas discharge section 42 positioned adjacent to hydrocarbon-bearing formation 14, shown with production zone 48 between packers 44, 46. When it is desired to treat the near-wellbore region (a region within about 25 (in some embodiments, 20, 15, or 10) feet of the wellbore) of hydrocarbon-bearing formation 14 adjacent to production zone 48, work string 30 and fluid delivery tube 40 are lowered through casing 34 until sand control screen assembly 38 and fluid discharge section 42 are positioned adjacent to the near-wellbore region of hydrocarbon-bearing formation 14 including perforations 50.

Thereafter, a treatment composition described herein is pumped down delivery tube 40 to progressively treat the near-wellbore region of hydrocarbon-bearing formation 14.

While the drawing depicts an offshore operation, the skilled artisan will recognize that the methods for treating a production zone of a wellbore are equally well-suited for use in onshore operations. Also, while the drawing depicts a vertical well, the skilled artisan will also recognize that methods according to the present disclosure are equally well-suited for use in deviated wells, inclined wells or horizontal wells.

### Selected Embodiments of the Disclosure

In a first embodiment, the present disclosure provides a method of treating a hydrocarbon-bearing formation, the method comprising:

receiving data comprising a temperature and a brine composition of the hydrocarbon-bearing formation;

selecting a treatment composition for the hydrocarbon-bearing formation comprising a fluorinated compound and solvent, wherein, at the temperature, a mixture of an amount of the brine composition and the treatment composition separates into at least two separate transparent liquid layers, and wherein the mixture is free of precipitated solid; and

contacting the hydrocarbon-bearing formation with the treatment composition, wherein the hydrocarbon-bearing formation has at least one of a gas permeability or liquid permeability that is increased by more than 30 percent after the hydrocarbon-bearing formation is contacted with the treatment composition.

In a second embodiment, the present disclosure provides a method of treating a hydrocarbon-bearing formation, the method comprising:

receiving data comprising a temperature and a brine composition of the hydrocarbon-bearing formation;

selecting a treatment composition for the hydrocarbon-bearing formation comprising a fluorinated compound and solvent comprising at least one of a ketone, ester, ether, each having from 4 to 10 carbon atoms, or a hydrofluoroether or hydrofluorocarbon, wherein, at the temperature, a mixture of an amount of the brine composition and the treatment composition separates into at least two separate transparent liquid layers, and wherein the mixture is free of precipitated solid; and

contacting the hydrocarbon-bearing formation with the treatment composition.

In a third embodiment, the present disclosure provides a method according to embodiment 1 or 2, wherein the fluorinated compound is a fluorinated polymer comprising:

at least one divalent unit represented by the formula:

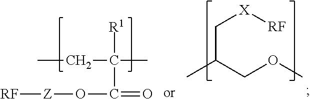

and a polyalkyleneoxy segment,

wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—;
each X is independently —N(R)SO₂—, —N(R)CO—, —O—CᵥH₂ᵥ—, —S—CᵥH₂ᵥ—, or —C_{w}H_{2w}—, wherein p and q are each values from 0 to 6; and
R and R¹ are each independently selected from the group consisting of hydrogen and alkyl having up to 4 carbon atoms.

In a fourth embodiment, the present disclosure provides a method according to embodiment 3, wherein the fluorinated polymer comprises:

a nonionic polymer comprising:
at least one divalent unit represented by formula:

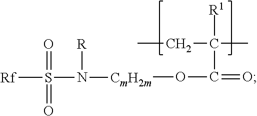

and at least one unit selected from the group consisting of:

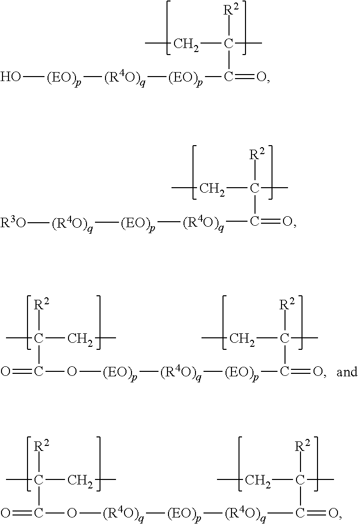

wherein
Rf represents a fluoroalkyl group having up to 10 carbon atoms;
R, R¹, R², and R³ are each independently selected from the group consisting of hydrogen and alkyl having up to 4 carbon atoms;
m is an integer from 1 to 11;
EO represents —CH₂CH₂O—;
each R⁴O is independently selected from the group consisting of

—CH(CH₃)CH₂O—, —CH₂CH₂CH₂O—, —CH₂CH(CH₃)O—,

—CH(CH₂CH₃)CH₂O—, —CH₂CH(CH₂CH₃)O—, and —CH₂C(CH₃)₂O—;
each p is independently 1 to 150; and
each q is independently 0 to 55.

In a fifth embodiment, the present disclosure provides a method according to embodiment 1 or 2, wherein the fluorinated compound comprises:

a fluorinated polyurethane having at least two repeat units, the fluorinated polyurethane comprising:
at least one end group represented by the formula -A¹-Z—RF, and
at least one end group represented by the formula -A¹-W—SiG₃;

wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—, wherein each R is independently hydrogen or alkyl having up to four carbon atoms;
each A¹ is independently selected from the group consisting of —NH—C(O)—N(R¹¹)—, —NH—C(O)—S—, —NH—C(O)—O—, —N(R¹¹)—C(O)—NH—, and —O—C(O)—NH—, wherein R¹¹ is hydrogen or alkyl having up to four carbon atoms;
each W is independently selected from the group consisting of alkylene, arylalkylene, and arylene, wherein alkylene is optionally interrupted with at least one —O—; and
each G is independently hydroxyl, alkoxy, acyloxy, aryloxy, halogen, alkyl, or phenyl, with the proviso that at least one G is hydroxyl, alkoxy, acyloxy, aryloxy, or halogen.

In a sixth embodiment, the present disclosure provides a method according to embodiment 5, wherein the end group represented by formula -A¹-Z—RF is —NH—C(O)—O—(CⱼH₂ⱼ)N(R″)S(O)₂—Rf², and wherein the end group represented by formula -A¹-W—SiG₃ is —NH—(CₖH₂ₖ)—SiG′₃, wherein Rf² is perfluoroalkyl having from 2 to 6 carbon atoms, R″ is hydrogen or alkyl having up to four carbon atoms; each G′ is independently alkoxy or hydroxyl; and j and k are each independently 1 to 6.

In a seventh embodiment, the present disclosure provides a method according to embodiment 1 or 2, wherein the fluorinated compound comprises at least one of perfluorobutyl, perfluoropentyl, or perfluorohexyl groups.

In an eighth embodiment, the present disclosure provides a method according to any one of embodiments 1 or 7, wherein the solvent comprises a ketone having from 4 to 10 carbon atoms or a hydrofluoroether.

In a ninth embodiment, the present disclosure provides a method according to embodiment 8, wherein the solvent further comprises water and a monohydroxy alcohol having up to 6 carbon atoms.

In a tenth embodiment, the present disclosure provides a method according to embodiment 9, wherein the water is present in a range from 2 to 40 percent by weight, based on the total weight of the treatment composition.

In an eleventh embodiment, the present disclosure provides a method according to embodiment 8, 9, or 10, wherein the ketone comprises two different ketones, each having from 4 to 10 carbon atoms.

In a twelfth embodiment, the present disclosure provides a method according to any one of embodiments 8 to 11, wherein the ketone has from 5 to 10 carbon atoms.

In a thirteenth embodiment, the present disclosure provides a method according to any one of embodiments 8 to 12, wherein the ketone is present in a range from 15 to 60 percent by weight, based on the total weight of the treatment composition.

In a fourteenth embodiment, the present disclosure provides a method according to any one of embodiments 1 to 13, wherein the treatment composition further comprises a scale inhibitor.

In a fifteenth embodiment, the present disclosure provides a method according to any one of embodiments 1 to 14, wherein the amount of the brine composition in the mixture is in a range from 5 to 95 percent by weight, based on the total weight of the mixture.

In a sixteenth embodiment, the present disclosure provides a method according to any one of embodiments 1 to 15, wherein the brine composition comprises at least 150,000 milligrams per liter of total dissolved salts.

In a seventeenth embodiment, the present disclosure provides a method according to any one of embodiments 1 to 16, wherein the brine composition comprises at least one of sulfate or borate ions.

In an eighteenth embodiment, the present disclosure provides a method according to any one of embodiments 1 to 17, wherein the hydrocarbon-bearing formation comprises at least one of sandstone, shale, conglomerate, diatomite, or sand.

In a nineteenth embodiment, the present disclosure provides a method according to any one of embodiments 1 to 18, wherein the hydrocarbon-bearing formation comprises at least one of carbonates or limestone.

In a twentieth embodiment, the present disclosure provides a method according to any one of embodiments 1 to 19, wherein the hydrocarbon-bearing formation has at least one fracture, and wherein the fracture has a plurality of proppants therein.

In a twenty-first embodiment, the present disclosure provides a method according to embodiment 1 or 2, wherein the fluorinated compound is a fluorinated silane.

In a twenty-second embodiment, the present disclosure provides a method according to any one of embodiments 1 to 21, wherein the selecting a treatment composition comprises consulting a table of compatibility data between brines and treatment compositions at different temperatures.

In a twenty-third embodiment, the present disclosure provides a method of treating a hydrocarbon-bearing formation, the method comprising:

receiving data comprising a temperature and a first brine composition of the hydrocarbon-bearing formation;

contacting the hydrocarbon-bearing formation with a fluid, wherein after the fluid contacts the hydrocarbon-bearing formation, the hydrocarbon-bearing formation has a second brine composition that is different from the first brine composition;

selecting a treatment composition for the hydrocarbon-bearing formation comprising a fluorinated compound and solvent, wherein, at the temperature, a mixture of an amount of the second brine composition and the treatment composition separates into at least two separate transparent liquid layers, and wherein the mixture is free of precipitated solid; and

contacting the hydrocarbon-bearing formation with the treatment composition.

In a twenty-fourth embodiment, the present disclosure provides a composition comprising:

a fluorinated polymer comprising:
at least one divalent unit represented by formula:

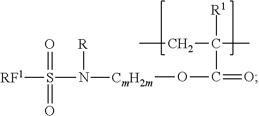

and at least one unit selected from the group consisting of:

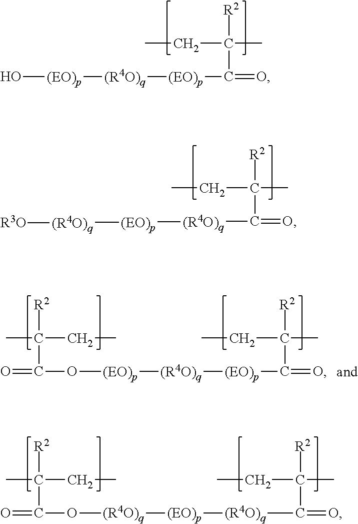

wherein
Rf¹ represents a perfluoroalkyl group having up to 8 carbon atoms;
   R, R¹, R², and R³ are each independently selected from the group consisting of hydrogen and alkyl having up to 4 carbon atoms;
   m is an integer from 2 to 11;
   EO represents —CH₂CH₂O—;
   each R⁴O is independently selected from the group consisting of

—CH(CH₃)CH₂O—, —CH₂CH₂CH₂O—, —CH₂CH(CH₃)O—,

—CH(CH₂CH₃)CH₂O—, —CH₂CH(CH₂CH₃)O—, and —CH₂C(CH₃)₂O—;
each p is independently 1 to 150; and
each q is independently 0 to 55; and solvent comprising:
water in a range from 5 to 40 percent by weight, based on the total weight of the composition;
a monohydroxy alcohol having up to 4 carbon atoms in a range from 25 to 60 percent by weight, based on the total weight of the composition; and
a ketone having from 4 to 10 carbon atoms in a range from 15 to 60 percent by weight, based on the total weight of the composition.

In a twenty-fourth embodiment, the present disclosure provides a composition comprising:

a fluorinated polyurethane having at least two repeat units, the fluorinated polyurethane comprising:
at least one end group represented by the formula

—NH—C(O)—O—(CⱼH₂ⱼ)N(R″)S(O)₂—Rf²; and
at least one end group represented by the formula —NH—(CₖH₂ₖ)—SiG′₃; wherein
each Rf² independently represents perfluoroalkyl having from 2 to 6 carbon atoms;
each R″ is independently hydrogen or alkyl having up to four carbon atoms;
each G′ is independently alkoxy or hydroxyl; and
j and k are each independently values from 1 to 6; and solvent comprising:

water in a range from 5 to 40 percent by weight, based on the total weight of the composition;

a monohydroxy alcohol having up to 4 carbon atoms in a range from 25 to 60 percent by weight, based on the total weight of the composition; and

a ketone having from 4 to 10 carbon atoms in a range from 15 to 60 percent by weight, based on the total weight of the composition.

In a twenty-sixth embodiment, the present disclosure provides a composition according to embodiment 24 or 25, wherein the ketone comprises two different ketones, one having from 4 to 10 carbon atoms and one having from 5 to 10 carbon atoms.

Advantages and embodiments of this disclosure are further illustrated by the following examples, but the particular materials and amounts thereof recited in these examples, as well as other conditions and details, should not be construed to unduly limit this disclosure. Unless otherwise noted, all parts, percentages, ratios, etc. in the examples and the rest of the specification are by weight. In the Tables, “nd” means not determined.

### EXAMPLES

In the following Examples, a nonionic fluorinated polymeric surfactant (“Nonionic Fluorinated Polymeric Surfactant A”) was prepared essentially as in Examples 2A, 2B, and 4 of U.S. Pat. No. 6,664,354 (Savu et al.), incorporated herein by reference, except using 4270 kilograms (kg) of N-methylperfluorobutanesulfonamidoethanol, 1.6 kg of phenothiazine, 2.7 kg of methoxyhydroquinone, 1590 kg of heptane, 1030 kg of acrylic acid, 89 kg of methanesulfonic acid (instead of triflic acid), and 7590 kg of water in the procedure of Example 2B and using 15.6 grams of 50/50 mineral spirits/TRIGONOX-21-C50 organic peroxide initiator (tert-butyl peroxy-2-ethylhexanoate obtained from Akzo Nobel, Arnhem, The Netherlands) in place of 2,2′-azobisisobutyronitrile, and with 9.9 grams of 1-methyl-2-pyrrolidinone added to the charges in the procedure of Example 4.

In the following examples, a fluorinated polyurethane was used. The “Fluorinated Polyurethane A” was prepared as follows. To a 250 mL dry flask was added 102 g (mw 585, 0.0697 equiv. —NCO) of the isocyanurate of HDI (obtained from Bayer Corporation as DESMODUR N-3300); 12.2 g (mw 135, 0.020 equiv. -OH) dimethanolpropionic acid; 95 g (mw 357, 0.041mole) N-methylperfluorobutanesulfonamidoethanol (prepared as described in Example 2A of U.S. Pat. No. 6,664,354 (Savu et al.)); and 260 g ethyl acetate. Dibutyltin dilaurate catalyst (0.5 g) was added. The reaction was carried out under agitation at 60° C. for three hours. Aminopropyltriethoxysilane (8.5 g, 221.4, 0.0033 mole) was then added and the reaction was maintained at 60° C. for one hour. DPM (68 g) was added and mixed for 30 minutes. A pre-mix of methyldiethanolamine in 990 g DI Water was charged at 60° C. The ethyl acetate was then stripped off under reduced pressure to give the final product, in which the % solid of urethane was 15%.

### Comparative Examples A and B

For Comparative Examples A and B (Comp. A and B), the “Nonionic Fluorinated Polymeric Surfactant A” was combined as shown in Table 1, below, wherein the weight percentages were based upon the total weight percentage of the composition. The “Nonionic Fluorinated Polymeric Surfactant A” was added to a flask containing either isopropyl alcohol or ethanol and mixed together using a magnetic stirrer and a magnetic stir bar for 30 minutes. Propylene glycol or 1-butoxy ethanol were then added to the mixture and stirred for 15 minutes.

TABLE 1

| | “Nonionic | | | | |
|---|---|---|---|---|---|
| | Fluorinated | Isopropyl | | Propylene | 2-Butoxy |
| | Polymeric Sur- | alcohol | Ethanol | Glycol | Ethanol |
| Example | factant A”. (%) | (IPA) (%) | (%) | (%) | (%) |
| Comp. A | 2.0 | 29.0 | none | 69.0 | none |
| Comp. B | 2.0 | none | 29.0 | none | 69.0 |

### Examples 1 to 7 and Comparative Example C (Comp. C)

Examples 1 to 8 were prepared by adding a designated amount of the “Nonionic Fluorinated Polymeric Surfactant A” to designated solvent blends as shown in Table 2, below, wherein the weight percentages were based upon the total weight percentage of the composition. The components were mixed together using a magnetic stirrer and a magnetic stir bar for 30 minutes. Deionized (DI) water was subsequently added to the mixture and stirred for 15 minutes.

TABLE 2

| | “Nonionic | | Methy | Methyl | | | |
|---|---|---|---|---|---|---|---|
| | Fluorinated | Isopropyl | Ethyl | Isobutyl | | | |
| | Polymeric | alcohol | Ketone | Ketone | | DI | Polyacrylic |
| | Surfactant | (IPA) | (MEK) | (MIBK) | Toluene | Water | Acid |
| Example | A”. (%) | (%) | (%) | (%) | (%) | (%) | (PAA) (%) |
| 1 | 0.9 | 35.7 | 35.7 | 17.7 | none | 10.0 | none |
| 2 | 0.9 | 35.7 | 35.7 | 17.7 | none | 10.0 | 0.05 |
| 3 | 1.0 | 29.1 | 29.1 | 14.8 | none | 26.0 | 0.04 |
| 4 | 1.0 | 49.0 | none | 20.0 | none | 30 | 0.8 |
| 5 | 1.0 | 44.0 | none | 25.0 | none | 30 | 0.8 |
| 6 | 1.0 | 44.0 | 5.0 | 20.0 | none | 30 | 0.8 |
| 7 | 2.0 | 44.0 | none | none | 44.0 | 10 | none |
| Comp. | 2.0 | 88.0 | none | none | none | 10 | none |
| C | | | | | | | |

### Comparative Example D (Comp. D), and Examples 9 and 10

The “Fluorinated Polyurethane A” was combined with solvent blends as shown in Table 3, below, wherein the weight percentages were based upon the total weight percentage of the composition. The compositions were prepared by adding a designated amount of the “Fluorinated Polyurethane A” to the designated solvent blends and mixed together using a magnetic stirrer and a magnetic stir bar for 30 minutes. Deionized (DI) water was subsequently added to the mixture and stirred for 15 minutes.

TABLE 3

| | | | Methy | Methyl | |
|---|---|---|---|---|---|
| | Fluorinated | Isopropyl | Ethyl | Isobutyl | DI |
| | Polyurethane | alcohol | Ketone | Ketone | water |
| Example | A (%) | (IPA) (%) | (MEK) (%) | (MIBK) (%) | (%) |
| Comp. D | 2.0 | 44.0 | none | none | 44.0 |
| 9 | 0.50 | 29.0 | 53.2 | 14.5 | 2.8 |
| 10 | 0.50 | 26.0 | 47.7 | 13.0 | 12.8 |

For Comparative Example D, 2% by weight of KC1 was added to the fluorinated polymer composition and stirred. There was much precipitation upon mixing. The liquid had a turbid to hazy appearance.

### Brine Compositions

Brines 1 to 5 were used in the Compatibility Evaluations and the Core Flood Examples. The brines were prepared by dissolving the amount of the compounds shown in Table 4, weighed with an analytical balance, in deionized water. Each solution was transferred to a 1000-mL volumetric flask, and water was added to grade while mixing it flipping the flask up and down. In Table 4, the “−” means none of the compound was added. The total dissolved salt for Brine 1 was 172,300 mg/L, for Brine 2 was 76,640 mg/L, for Brine 3 was 259,820 mg/L, for Brine 4 was 18, 300 mg/L, and for Brine 5 was 30,000 mg/L.

TABLE 4

| | Brine 1 | Brine 2 | Brine 3 | Brine 4 | Brine 5 |
|---|---|---|---|---|---|
| Ions | (g/L) | (g/L) | (g/L) | (g/L) | (g/L) |
| NaCl | 88.94 | 59.00 | 222.1 | 16.74 | — |
| CaCl₂•2H₂O | 85.94 | 16.00 | 24.30 | 0.310 | — |
| MgCl₂•6H₂O | 8.24 | 3.50 | 21.19 | 0.167 | — |
| KCl | 3.92 | — | 1.67 | 0.063 | 30.0 |
| SrCl₂•6H₂O | 5.17 | — | 0.74 | 0.064 | — |
| BaCl₂ | 2.30 | — | 0.002 | — | — |
| MnCl₂ | — | — | — | 0.002 | — |
| H₃BO₃ | — | — | — | 0.057 | — |
| NaHCO₃ | 0.010 | — | — | — | — |
| Na₂SO₄ | 0.37 | — | 1.16 | 0.976 | — |
| FeCl₂ | — | — | — | 0.220 | |

### Compatibility Evaluations

About three grams of one of the above-described compositions containing a fluorinated compound was added to a vial to prepare a sample. Brine was added in 0.25 gram increments to the vial, and the vial was placed in a heated bath at a predetermined temperature for 15 minutes. The temperature used for each brine is shown in Table 5, below. The vial was removed from the bath, and then visually inspected immediately to determine whether the sample was one-phase or two-phase and whether the sample was clear, hazy, or cloudy.

TABLE 5

| | Temperature used for |
|---|---|
| Brine | compatibility test (° C.) |
| 1 | 146 |
| 2 | 135 |
| 3 | 52 |
| 4 | 93 |
| 5 | 121 |

The Examples used for each compatibility evaluation are shown in Table 6, below, wherein the numbers indicate weight percentages of brine based on the combined total weight of the solvents, brine, and fluorinated compound. The range of brine that provided a clear two-phase mixture is shown in Table 6, below, with a numerical range and sometimes a footnote. However, if the mixture was not two-phase or was hazy, cloudy, or otherwise incompatible, this is also noted in the table.

TABLE 6

| Examples | Brine 1 (%) | Brine 2 (%) | Brine 3 (%) | Brine 4 (%) | Brine 5 (%) |
|---|---|---|---|---|---|
| Comp. | Clear 1-phase, ≦20 | n.d. | 1 phase, ≦5 | 1 phase, ≦36 | n.d. |
| Ex. A | | | | | |
| Comp. | 50 to 90 | n.d. | 1 phase, ≦0.7 | 1 phase, ≦10 | n.d. |
| Ex. B | | | | | |
| 1 | n.d. | n.d. | n.d. | 25 to 67.8^{c} | n.d. |
| 2 | n.d. | n.d. | n.d. | 25 to 65^{b} | n.d. |
| 3 | n.d. | n.d. | ≦70^{b} | 25 to 70^{b} | n.d. |
| 4 | 37.5 to 50^{d} | n.d. | 12.3^{d} | n.d. | n.d. |
| 5 | 2-phase, hazy | n.d. | 7.0 to 10.4^{b} | n.d. | n.d. |
| | 38.3 to 50.5^{d} | | | | |
| 6 | 4.4 to 90.2^{a} | 12.1 to 78.3^{a} | 3.7 to 95.3^{b} | 28.9 to 66.9^{a} | n.d. |
| 7 | 2-phase, hazy | 16.38 to 60.2^{f} | Incompatable | Incompatable | n.d. |
| | 6.9 to 50^{d} | | 3.5 to 52.1^{e} | 8.8 to 12.1^{e} | |
| Comp. | Cloudy 1 or | 1-phase ≦45.5; | Incompatable | 1-phase 29.6; Cloudy | n.d. |
| Ex. C | 2-phase: 6.9 to 50^{d} | Incompatable | 2 to 47.6^{h} | 1-phase, 50 to 60^{d} | |
| | | 50.0 to 70.1^{g} | | | |
| Comp. | n.d. | n.d. | n.d. | n.d. | 2-phase (precipitate, |
| Ex. D | | | | | hazy) |
| 9 | n.d. | n.d. | n.d. | n.d. | 14.2 to 70.0^{b} |
| 10 | n.d. | n.d. | n.d. | n.d. | 17.5 to 70^{b} |

^{a}At lower concentrations, the mixture was one-phase, at higher concentrations, the mixture became hazy.
^{b}At lower concentrations, the mixture was one-phase; compatibility was not determined at higher concentrations.
^{c}Mixture was one-phase and clear up to 10% and cloudy between 12% and 20%; compatibility was not determined at higher concentrations.
^{d}Compatibility was not determined outside of the listed range.
^{e}Mixture was two-phase and was either cloudy, hazy, or had precipitate.
^{f}Mixture was two-phase and either cloudy or hazy above and below this range.
^{g}Mixture was one-phase and either cloudy or hazy in this range.
^{h}Mixture was one-phase at less than 10% and two-phase at more than 10% and either cloudy, hazy, or had precipitate at all tested amounts.

### Permeability Evaluation for Comparative Examples A and B.

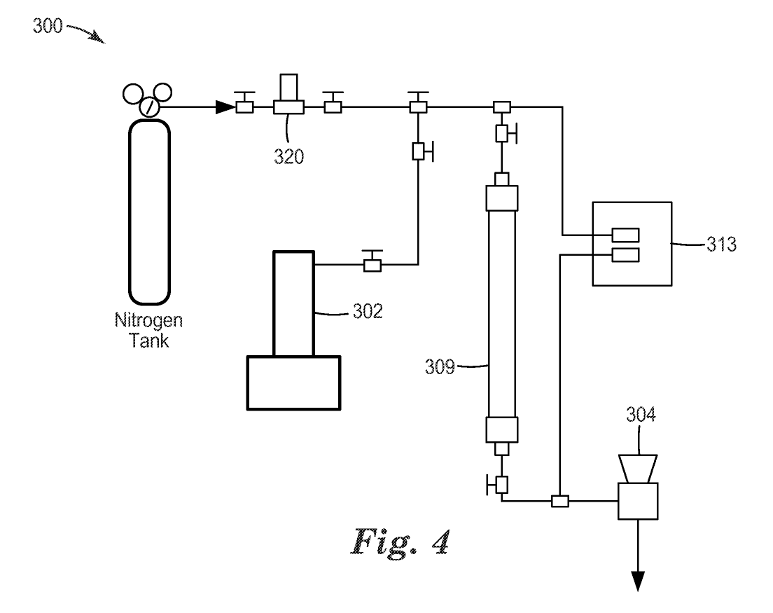

A schematic diagram of a flow apparatus 300 used to determine relative permeability of sea sand or particulate calcium carbonate is shown in FIG. 4. Flow apparatus 300 included positive displacement pump 302 (Model Gamma/4-W 2001 PP, obtained from Prolingent AG, Regensdorf, Germany). Nitrogen gas was injected at constant rate through a gas flow controller 320 (Model DK37/MSE, Krohne, Duisburg, Germany). Pressure indicators 313, obtained from Siemens under the trade designation “SITRANS P” 0-16 bar, were used to measure the pressure drop across a sea sand pack in vertical core holder 309 (20 cm by 12.5 cm²) (obtained from 3M Company, Antwerp, Belgium). A back-pressure regulator (Model No. BS(H)2; obtained from RHPS, The Netherlands) 304 was used to control the flowing pressure upstream and downstream of core holder 309. Core holder 309 was heated by circulating silicone oil, heated by a heating bath obtained from Lauda, Switzerland, Model R22.

The core holder was filled with sea sand (obtained from from Aldrich, Bornem, Belgium, grade 60-70 mesh) and then heated to 75° C. A pressure of about 5 bar (5×10⁵ Pa.) was applied, and the back pressure was regulated in such a way that the flow of nitrogen gas through the sea sand was about 500 to 1000 mL/minute. The initial gas permeability was calculated using Darcy's law.

Brine composition 3 was introduced into the core holder at about 1 mL/minute using displacement pump 302, and the pre-treatment permeability was measured.

The treatment composition (Comp. A or B) was then injected into the core at a flow rate of 1 mL/minute for about one pore volume. The gas permeability after treatment was calculated from the steady state pressure drop, and improvement factor was calculated as the permeability after treatment divided by permeability before treatment. Brine composition 3 was then reinjected and the permeability measured.

In two runs, a pre-flush treatment was used. The pre-flush treatment consisted of introducing isopropyl alcohol (IPA) or a mixture of IPA and deionized water (50/50 in volume) into the core holder at about 1 mL/minute before the treatment with the treatment composition.

For Comparative Examples A and B, with and without pre-flush, the measured permeability of the core (K_{abs}), the gas permeability pre-treatment (Kₚᵣₑ), the gas permeability post-treatment (Kₚₒₛₜ), the improvement factor (PI), and the permeability of the core after brine composition 3 is re-injected (K_{brine}), are shown in Table 7, below.

TABLE 7

| | K_{abs} | Kₚᵣₑ | Kₚₒₛₜ | | K_{brine} |
|---|---|---|---|---|---|
| Liquid | (mD) | (mD) | (mD) | PI | (mD) |
| Comp. A | 32.0 | 1.6 | 2.6 | 1.6 | Total |
| | | | | | block |
| Comp. B | 25.4 | 2.2 | 3.1 | 1.4 | Total |
| | | | | | block |
| IPA preflush then | 26.7 | 2.1 | 3.6 | 1.7 | Total |
| Comp. A | | | | | block |
| IPA/Water (50/50) | 27.2 | 3.0 | 5.4 | 1.8 | Total |
| preflush then Comp. A | | | | | block |

### Example 11

Core Flood Evaluation for Example 3 with Brine Composition 4.

A core sample was cut from a sandstone block obtained from Cleveland Quarries, Vermillion, Ohio, under the trade designation “BEREA SANDSTONE”. The core had a length of 7.72 cm, a diameter of 2.47 cm, and a pore volume of 6.8 mL.

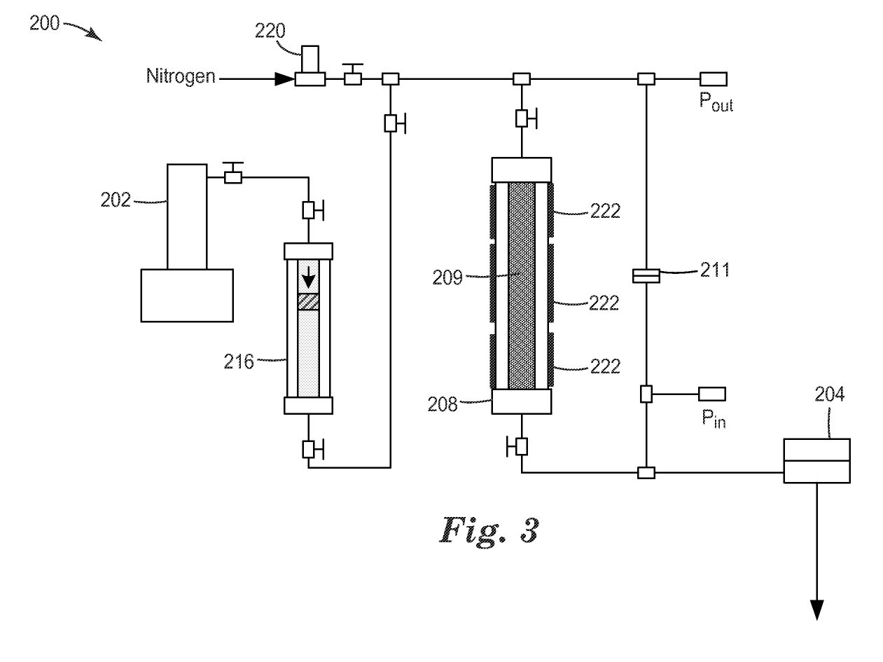

A schematic diagram of a core flood apparatus 200 used to determine relative permeability of a substrate sample (i.e., core) is shown in FIG. 3. Core flood apparatus 200 included positive displacement pump 202 (Model QX6000SS, obtained from Chandler Engineering, Tulsa, Okla.) to inject n-heptane at constant rate into fluid accumulators 216. Nitrogen gas was injected at constant rate through a gas flow controller 220 (Model 5850 Mass Flow Controller, Brokks Instrument, Hatfield, Pa.). A pressure port 211 on high-pressure core holder 208 (Hassler-type Model RCHR-1.0 obtained from Temco, Inc., Tulsa, Okla.) were used to measure pressure drop across the vertical core 209. A back-pressure regulator (Model No. BP-50; obtained from Temco, Tulsa, Okla.) 204 was used to control the flowing pressure downstream of core 209. High-pressure core holder 208 was heated with 3 heating bands 222 (Watlow Thinband Model STB4A2AFR-2, St. Louis, Mo.).

The core was dried for 72 hours in a standard laboratory oven at 95° C. and then wrapped in aluminum foil and heat shrink tubing. Referring again to FIG. 3, the wrapped core 209 was placed in core holder 208 at 75° F. (24° C.). An overburden pressure of 2300 psig (1.6×10⁷ Pa) was applied. The initial single-phase gas permeability was measured using nitrogen at low system pressures between 5 to 10 psig (3.4×10⁴ to 6.9×10⁴ Pa).

Brine Composition 4 was introduced into the core 209 by the following procedure to establish a brine saturation of 35% (i.e., 35% of the pore volume of the core was saturated with brine). The outlet end of the core holder was connected to a vacuum pump and a full vacuum was applied for 30 minutes with the inlet closed. The inlet was connected to a burette with the brine in it. The outlet was closed and the inlet was opened to allow 2.1 mL of brine to flow into the core. The inlet and the outlet valves were then closed for 16 hours. The gas permeability was measured at the brine saturation by flowing nitrogen at 500 psig (3.4×10⁶ Pa) and 75° F. (24° C.).

The core holder 208 was then heated to 250° F. (121° C.) for several hours. Nitrogen and n-heptane were co-injected into the core at an average total flow rate in the core of 450 mL/hour at a system pressure of 900 psig (6.2×10⁶ Pa) until steady state was reached. The flow rate of nitrogen was controlled by gas flow controller 220, and the rate for n-heptane was controlled by positive displacement pump 202. The flow rates of nitrogen and n-heptane were set such that the fractional flow of gas in the core was 0.66. The gas relative permeability before treatment was then calculated from the steady state pressure drop. The treatment composition was then injected into the core at a flow rate of 120 mL/hour for 20 pore volumes. Nitrogen and n-heptane co-injection was resumed at an average total flow rate in the core of 450 mL/hour at a system pressure of 900 psig (6.2×10⁶ Pa) until steady state was reached. The gas relative permeability after treatment was then calculated from the steady state pressure drop. The improvement factor is the ration of the gas relative permeability after treatment to the gas relative permeability before treatment.

The treatment composition, the measured initial permeability of the core (K_{abs}), the gas relative permeability pre and post-treatment (K_{rg}), the oil relative permeability pre and post-treatment (Kₘ), and the improvement factor (PI) are shown in Table 8, below.

TABLE 8

| Treatment | K_{abs} | Pre-treatment | | Post-Treatment | | |
|---|---|---|---|---|---|---|
| Composition | (mD) | K_{rg} | Kᵣₒ | K_{rg} | Kᵣₒ | PI |
| Example 3 | 172 | 0.0156 | 0.0559 | 0.022 | 0.078 | 1.4 |

### Example 12

Core Flood Evaluation for Example 3 with Brine Composition 3

A core sample was cut from a sandstone block as described in Example 11. The core had a length of 19.65 cm, a diameter of 2.48 cm, a pore volume of 16.8 mL, and a porosity of 17.7%.

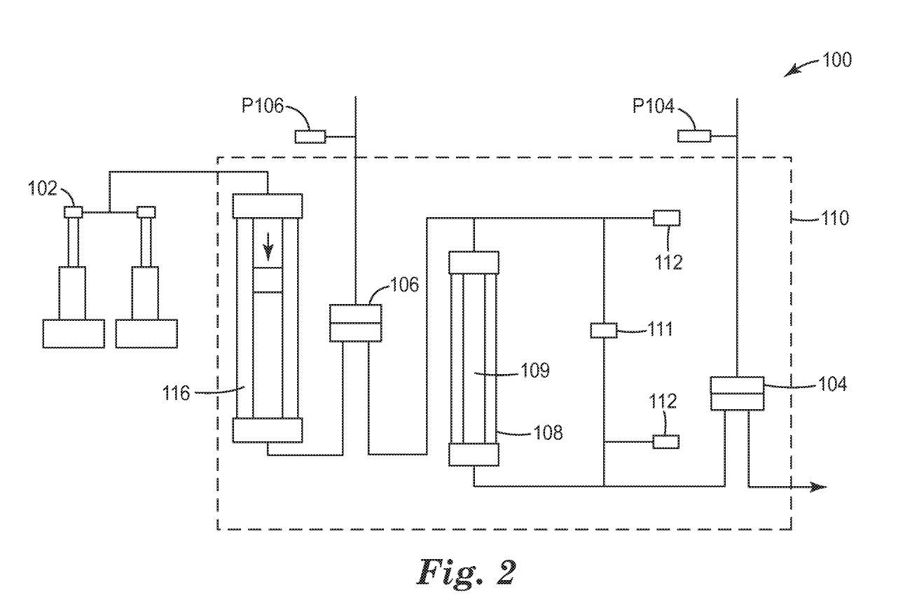

A schematic diagram of a core flood apparatus 100 used to determine relative permeability of a substrate sample (i.e., core) is shown in FIG. 2. Core flood apparatus 100 included positive displacement pump 102 (Model D-100; obtained from ISCO, Lincoln, Nebr.) to inject fluid at constant flow rates into fluid accumulator 116 (CFR series, obtained from Temco, Inc., Tulsa, Okla.). The pressure in the accumulator 116 was controlled and maintained by upstream back-pressure regulator 106 (Model No. BPR-100 obtained from Temco, Inc.). Pressure ports 112 on high-pressure core holder 108 (Hassler-type Model RCHR-1.0 obtained from Tempo, Inc.) was used to measure pressure drop across the vertical core 109 by a differential pressure regulator 111 (Model 3051 S obtained from Rosemount, Chanhassen, Minn.). The core pressure was regulated by a downstream back pressure regulator 104 (Model BPR-100 obtained from Tempo, Inc.). The pressures of back pressure regulators 104, 106 were measured at pressure ports P104, P106. The accumulator 116, the backpressure regulators 106, 104, and the coreholder 108 were all installed in an oven 110 (Model RFD2-19-2E obtained from Despatch, Lakeville, Minn.).

The core was dried for 72 hours in a standard laboratory oven at 95° C. and then wrapped in aluminum foil and heat shrink tubing. The wrapped core was then inserted into a fluorinated elastomer core sleeve and mounted onto the core holder. An overburden pressure of 1000 psi (6.8×10⁶ Pa) over the core pressure was applied in the core holder 108.

Fluid (e.g., nitrogen, gas condensate, or treatment solution) was delivered from accumulator 116 into the core 109. The absolute permeability of the core was measured with nitrogen at room temperature using at least four different flow rates to take the average. The result is shown in Table 9, below. After the absolute permeability measurement, Brine Composition 3 was introduced to the core by the following procedure to establish a saturation of 35% (i.e., 35% of the pore volume of the core was saturated with the brine). The outlet end of the core holder 108 was connected to a vacuum pump and a full vacuum was applied for 30 minutes with the inlet closed. The inlet was connected to a burette with the brine in it. The outlet was closed and the inlet was opened to allow the appropriate volume of brine to flow into the core. The inlet and outlet valves were then closed, and the brine was allowed to distribute in the core overnight. A synthetic gas condensate made from 93 mole % methane, 4 mole % butane, 2 mole % n-decane, and 1 mole % pentadecane was prepared by weighing each component into accumulator 116. The gas condensate was then placed into the oven 110 on a pneumatically controlled rocker allowing it to reach equilibrium overnight at 275° F. (135° C.).

The synthetic gas condensate was then injected into the core at a constant pump rate of 3.0 mL/minute. Upstream back-pressure regulator 106 was set at about 500 psi (3.4×10⁶ Pa) above the dew point pressure of the fluid, and downstream back-pressure regulator 104 was set at about 1500 psi (3.38×10⁷ Pa). The injection was continued until a steady state was reached. The gas relative permeability before treatment was then calculated from the steady state pressure drop. The treatment composition (Example 3) was then injected into the core. After at least about 20 pore volumes were injected, the treatment composition was held in the core at 275° F. (135° C.) for about 15 hours. The synthetic gas condensate fluid described above was then introduced again at the same rate using positive displacement pump 102 until a steady state was reached. The gas relative permeability after treatment was then calculated from the steady state pressure drop.

The treatment composition, the measured initial permeability of the core (K_{abs}), the gas relative permeability pre and post-treatment (K_{rg}), the oil relative permeability pre and post-treatment (Kₘ), and the improvement factor (PI) are shown in Table 9, below.

TABLE 9

| Treatment | K_{abs} | Pre-treatment | | Post-Treatment | | |
|---|---|---|---|---|---|---|
| Composition | (mD) | K_{rg} | Kᵣₒ | K_{rg} | Kᵣₒ | PI |
| Example 3 | 132 | 0.069 | 0.020 | 0.156 | 0.045 | 2.3 |

### Core Flood Evaluation for Comparative Example D

The setup and procedure described in Example 11 were used, except that the core was saturated with 26% brine and using brine composition 5. The two-phase flow was carried out with nitrogen and heptane at a liquid saturation of 25%. The Comparative Example D composition was injected as the treatment composition at a flow rate of 2 mL/min for 50 pore volumes, and held in the core for 15 hours before post-treatment core flood.

Characteristics of the core are shown in Table 10, below.

TABLE 10

| | |
|---|---|
| Length (cm) | 7.65 |
| Diameter (cm) | 2.46 |
| Pore volume (mL) | 6.8 |
| Porosity (%) | 18.7 |
| K_{abs} (mD) | 105 |

No improvement was observed. The improvement factor (PI) was 0.58. The core was partially blocked by the treatment composition.

### Core Flood Evaluation For Comparative Example A

The setup and procedure described in Example 11 were used with the modification that Comparative Example A was used as the treatment composition instead of Example 3. No improvement was observed in gas relative permeability or oil relative permeability.

### Example 13

### Core Flood Evaluation For Example 9 on Sandstone

For Example 13, the setup and procedure described in Example 12 were used, except that Example 9 was used as the treatment composition instead of Example 3, the core was saturated with 50% brine, using brine composition 5 and a treatment temperature of 150° F. (65.5° C.). The synthetic gas condensate composition was 89 mole % methane, 5 mole % butane, 2.5 mole % n-heptane, 2.5 mole % n-decane, and 1% pentadecane.

### Example 14

### Core Flood Evaluation For Example 9 on Sandstone

For Example 14, Example 13 was repeated except that a 2-phase gas-condensate flow was followed by a 3-phase gas-condensate-brine flow, injected at 7 mL/min. After the 3-phase flow, nitrogen was pushed to reduce the water saturation before the treatment composition was injected. 21 pore volumes of the Example 9 were injected as the treatment composition, then held for 30 minutes in the core. The post-treatment process started with the 2-phase flow, followed by the 3-phase flow.

For Examples 13 and 14, the treatment composition, the measured permeability of the core (K_{abs}), the pressure change pre and post-treatment(Δp), the gas relative permeability pre and post-treatment (K_{rg}), the oil relative permeability pre and post-treatment (Kᵣₒ), the capillary number pre and post-treatment (Nc) and the improvement factor (PI), are shown in Table 11, below.

TABLE 11

| | | Pre-treatment | | | | Post-treatment | | | | |
|---|---|---|---|---|---|---|---|---|---|---|
| | K_{abs} | Δp | | | | Δp | | | | |
| Liquid | (mD) | (psi) | K_{rg} | Kᵣₒ | Nc | (psi) | K_{rg} | Kᵣₒ | Nc | PI |
| Example 13 | 175 | 15.08 | 0.043 | 0.012 | 2.04 · 10⁻⁵ | 4.25 | 0.146 | 0.043 | 5.74 · 10⁻⁶ | 3.42 |
| Example 14 | 175 | 18.24 | 0.034 | 0.010 | 2.47 · 10⁻⁵ | 7.18 | 0.09 | 0.027 | 9.71 · 10⁻⁶ | 2.7 |

### Example 15

### Core Flood Evaluation For Example 9 on Limestone.

The setup and procedure described in Example 12 were used, except that Example 9 was used instead of Example 3, and the core material was cut from a block of limestone, (Texas cream limestone obtained from Texas Quarries, Round Rock, Tex.) having approximately a 7 millidarcy (mD) dry permeability. The core was saturated with 50% brine, using brine composition 5 and a treatment temperature of 150° F. (65.5° C.). Only 6 pore volumes of the fluorinated polymer composition were injected due to the low permeability of the core and were held in the core for 30 minutes prior to the post-treatment condensate flood. The synthetic gas condensate composition was 89 mole % methane, 5 mole % butane, 2.5 mole % n-heptane, 2.5 mole % n-decane, and 1% pentadecane.

For Example 15, the treatment composition, the measured permeability of the core (K_{abs}), the pressure change pre and post-treatment (Δp), the gas relative permeability pre and post-treatment (K_{rg}), the oil relative permeability pre and post-treatment (Kᵣₒ), the capillary number pre and post-treatment (Nc) and the improvement factor (PI), are shown in Table 12, below.

TABLE 12

| | | Pre-treatment | | | | Post-treatment | | | | |
|---|---|---|---|---|---|---|---|---|---|---|
| | K_{abs} | Δp | | | | Δp | | | | |
| Liquid | (mD) | (psi) | K_{rg} | Kᵣₒ | Nc | (psi) | K_{rg} | Kᵣₒ | Nc | PI |
| Example 9 (c) | 7 | 83.35 | 0.192 | 0.057 | 4.52 · 10⁻⁶ | 40.41 | 0.407 | 0.121 | 2.19 · 10⁻⁶ | 2.1 |

Various modifications and alterations of this disclosure may be made by those skilled the art without departing from the scope and spirit of the disclosure, and it should be understood that this disclosure is not to be unduly limited to the illustrative embodiments set forth herein.

1. A method of treating a hydrocarbon-bearing formation, the method comprising:
receiving data comprising a temperature and a brine composition of the hydrocarbon-bearing formation;
selecting a treatment composition for the hydrocarbon-bearing formation comprising a fluorinated compound and solvent, wherein, at the temperature, a mixture of an amount of the brine composition and the treatment composition separates into at least two separate transparent liquid layers, and wherein the mixture is free of precipitated solid; and
contacting the hydrocarbon-bearing formation with the treatment composition, wherein the hydrocarbon-bearing formation has at least one of a gas permeability or liquid permeability that is increased by more than 30 percent after the hydrocarbon-bearing formation is contacted with the treatment composition.

2. A method of treating a hydrocarbon-bearing formation, the method comprising:
receiving data comprising a temperature and a brine composition of the hydrocarbon-bearing formation;
selecting a treatment composition for the hydrocarbon-bearing formation comprising a fluorinated compound and solvent comprising at least one of a ketone, ester, ether, each having from 4 to 10 carbon atoms, or a hydrofluoroether or hydrofluorocarbon, wherein, at the temperature, a mixture of an amount of the brine composition and the treatment composition separates into at least two separate transparent liquid layers, and wherein the mixture is free of precipitated solid; and
contacting the hydrocarbon-bearing formation with the treatment composition.

3. The method according to claim 1, wherein the fluorinated compound is a fluorinated polymer comprising:
at least one divalent unit represented by the formula: 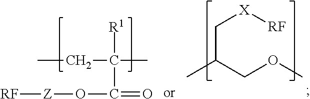
and a polyalkyleneoxy segment,
wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—;
each X is independently —N(R)SO₂—, —N(R)CO—, —O—CᵥH₂ᵥ—, —S—CᵥH₂ᵥ—, or —C_{w}H_{2w}—, wherein p and q are each values from 0 to 6; and
R and R¹ are each independently selected from the group consisting of hydrogen and alkyl having up to 4 carbon atoms.

4. The method according to claim 1, wherein the fluorinated compound comprises:
a fluorinated polyurethane having at least two repeat units, the fluorinated polyurethane comprising:
at least one end group represented by the formula -A¹-Z—RF, and
at least one end group represented by the formula -A¹-W—SiG₃;
wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)‘3, —SO₂N(R)—, —C(O)N(R)—, —C(O)—O—, —O—C(O)—, —OC(O)—N(R)—, —N(R)—C(O)—O—, or —N(R)—C(O)—N(R)—, wherein each R is independently hydrogen or alkyl having up to four carbon atoms;
each A¹ is independently selected from the group consisting of —NH—C(O)—N(R¹¹)—, —NH—C(O)—S—, —NH—C(O)—O—, —N(R¹¹)—C(O)—NH—, and —O—C(O)—NH—, wherein R¹¹ is hydrogen or alkyl having up to four carbon atoms;
each W is independently selected from the group consisting of alkylene, arylalkylene, and arylene, wherein alkylene is optionally interrupted with at least one —O—; and
each G is independently hydroxyl, alkoxy, acyloxy, aryloxy, halogen, alkyl, or phenyl, with the proviso that at least one G is hydroxyl, alkoxy, acyloxy, aryloxy, or halogen.

5. The method according to claim 1, wherein the solvent comprises a ketone having from 4 to 10 carbon atoms or a hydrofluoroether.

6. The method according to claim 5, wherein the solvent further comprises water and a monohydroxy alcohol having up to 6 carbon atoms.

7. The method according to claim 6, wherein the water is present in a range from 2 to 40 percent by weight, based on the total weight of the treatment composition.

8. The method according to claim 5any one of claims 5, wherein the ketone comprises two different ketones, each having from 4 to 10 carbon atoms.

9. The method according to claim 5any one of claims 5, wherein the ketone has from 5 to 10 carbon atoms.

10. The method according to claim 5any one of claims 5, wherein the ketone is present in a range from 15 to 60 percent by weight, based on the total weight of the treatment composition.

11. The method according to claim 1, wherein the brine composition comprises at least 150,000 milligrams per liter of total dissolved salts, or wherein the brine composition comprises at least one of sulfate or borate ions.

12. The method according to claim 1, wherein the fluorinated compound is a fluorinated silane.

13. TheA method according to claim 1, further comprising:
receiving data comprising a temperature and a second brine composition of the hydrocarbon-bearing formation;
contacting the hydrocarbon-bearing formation with a fluid, wherein after the fluid contacts the hydrocarbon-bearing formation, the hydrocarbon-bearing formation has the brine composition, which is different from the second brine composition.

14. A composition comprising solvent and one of a fluorinated polymer or a fluorinated polyurethane with at least two repeat units,
the fluorinated polymer comprising:
at least one divalent unit represented by formula: 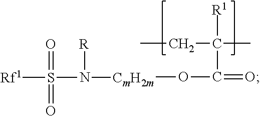
and at least one unit selected from the group consisting of: 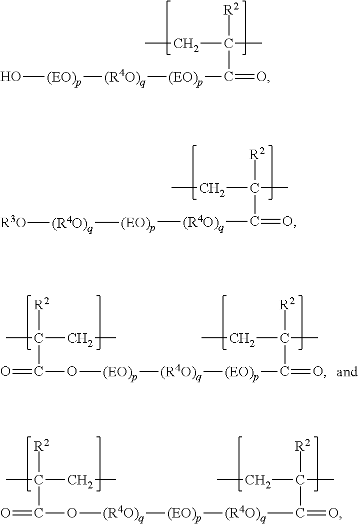
wherein
Rf¹ represents a perfluoroalkyl group having up to 8 carbon atoms;
R, R¹, R², and R³ are each independently selected from the group consisting of hydrogen and alkyl having up to 4 carbon atoms;
m is an integer from 1 to 11;
EO represents —CH₂CH₂O—;
each R⁴O is independently selected from the group consisting of —CH(CH₃)CH₂O—, —CH₂CH₂CH₂O—, —CH₂CH(CH₃)O—, —CH(CH₂CH₃)CH₂O—, —CH₂CH(CH₂CH₃)O—, and —CH₂C(CH₃)₂O—;
each p is independently 1 to 150; and
each q is independently 0 to 55;
the fluorinated polyurethane comprising:
at least one end group represented by the formula
—NH—C(O)—O—(CⱼH₂ⱼ)N(R″)S(O)₂—Rf²; and
at least one end rou represented b the formula —NH—CHₖH₂ₖ)—SiG′₃;
wherein
each Rf² independently represents perfluoroalkyl having from 2 to 6 carbon atoms;
each R″ is independently hydrogen or alkyl having up to four carbon atoms;
each G′ is independently alkoxy or hydroxyl; and
j and k are each independently values from 1 to 6; and the solvent comprising:
water in a range from 5 to 40 percent by weight, based on the total weight of the composition;
a monohydroxy alcohol having up to 4 carbon atoms in a range from 25 to 60 percent by weight, based on the total weight of the composition; and
a ketone having from 4 to 10 carbon atoms in a range from 15 to 60 percent by weight, based on the total weight of the composition.

15. (canceled)

16. The method according to claim 2, wherein the fluorinated compound is a fluorinated polymer comprising:
at least one divalent unit represented by the formula: 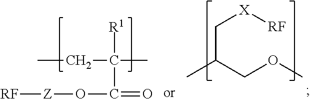
and a polyalkyleneoxy segment,
wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—, —C(O)N(R)—, —C(O)—O—, —O—C(O)—, —OC(O)—N(R)—, —N(R)—C(O)—O—, or —N(R)—C(O)—N(R)—;
each X is independently —N(R)SO₂—, —N(R)CO—, —O—CᵥH₂ᵥ—, —S—CᵥH₂ᵥ—, or —C_{w}H_{2w}—, wherein p and q are each values from 0 to 6; and
R and R¹ are each independently selected from the group consisting of hydrogen and alkyl having up to 4 carbon atoms.

17. The method according to claim 2, wherein the fluorinated compound comprises:
a fluorinated polyurethane having at least two repeat units, the fluorinated polyurethane comprising:
at least one end group represented by the formula -A¹-Z—RF, and
at least one end group represented by the formula -A¹-W—SiG₃;
wherein
each RF independently represents a fluoroalkyl group optionally containing at least one —O—;
each Z is independently selected from the group consisting of alkylene, alkylarylene, and arylalkylene, each of which is optionally interrupted or terminated with at least one of —O—, —C(O)—, —S(O)₀₋₂—, —N(R)—, —SO₂N(R)—,
—C(O)N(R)—, —C(O)—O—, —O—C(O)—, —OC(O)—N(R)—, —N(R)—C(O)—O—, or —N(R)—C(O)—N(R)—, wherein each R is independently hydrogen or alkyl having up to four carbon atoms;
each A¹ is independently selected from the group consisting of —NH—C(O)—N(R¹¹)—, —NH—C(O)—S—, —NH—C(O)—O—, —N(R¹¹)—C(O)—NH—, and —O—C(O)—NH—, wherein R¹¹ is hydrogen or alkyl having up to four carbon atoms;
each W is independently selected from the group consisting of alkylene, arylalkylene, and arylene, wherein alkylene is optionally interrupted with at least one —O—; and
each G is independently hydroxyl, alkoxy, acyloxy, aryloxy, halogen, alkyl, or phenyl, with the proviso that at least one G is hydroxyl, alkoxy, acyloxy, aryloxy, or halogen.

18. The method according to claim 2, wherein the solvent comprises a ketone having from 4 to 10 carbon atoms or a hydrofluoroether.

19. The method according to claim 18, wherein the solvent further comprises water and a monohydroxy alcohol having up to 6 carbon atoms.

20. The method according to claim 18, wherein the ketone comprises two different ketones, each having from 4 to 10 carbon atoms.

21. The method according to claim 18, wherein the fluorinated compound is a fluorinated silane.
